(19) United States
(12) Patent Application Publication
(10) Pub. No.: US 2003/0175164 A1
(43) Pub. Date: Sep. 18, 2003

(54) Devices, systems, and methods of manifolding materials

(75) Inventors: Kenneth J. Micklash II, San Diego, CA (US); Robert C. Downs, La Jolla, CA (US); Kristina Burow, Cardiff-by-the-Sea, CA (US); Brad Backes, Cardiff-by-the-Sea, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 10/350,802

(22) Filed: Jan. 24, 2003

Related U.S. Application Data
(60) Provisional application No. 60/351,821, filed on Jan. 25, 2002.

(51) Int. Cl. B01J 19/00

(52) U.S. Cl. 422/100; 422/102; 422/130; 422/131

(57) ABSTRACT

The present invention provides devices, systems, and methods of manifolding or distributing materials to and/or from reaction wells of multiple reaction blocks. Materials are distributed through multiple surfaces of reaction blocks without exposing reaction well contents to external environments. The invention further provides reaction block carriers to array multiple reaction blocks for use in the manifolding devices and systems.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### CROSS-REFERENCES TO RELATED APPLICATIONS

Pursuant to 35 U.S.C. § 119, the present application claims the benefit of and priority to U.S. application Ser. No. 60/351,821, filed on Jan. 25, 2002 by Micklash II et al., the disclosure of which is incorporated by reference in its entirety for all purposes.

### STATEMENT AS TO RIGHTS TO INVENTIONS MADE UNDER FEDERALLY SPONSORED RESEARCH AND DEVELOPMENT

Not Applicable.

### BACKGROUND OF THE INVENTION

Modern processes for discovering compounds with desired chemical or physical properties typically entail producing complex libraries of compounds that are methodically screened to identify members having the desired properties. One general approach to library construction involves creating compounds using combinatorial, parallel, or other synthetic processes in which sets of compounds are prepared from sets of building blocks, e.g., via multi-step solution- or solid-phase synthesis. For example, solid-phase synthesis generally includes covalently linking one of the reactants of a synthetic scheme to a solid support. An excess of other reactants may then be used to force the reactions forward, with non-support-bound reagents typically being washed away from the solid-phase upon the completion of the reactions. Multiple cycles of reactions and washes are generally performed to produce more complex libraries. Following synthesis, the linkage groups are typically cleaved to release the diverse products from the solid supports.

A wide variety of synthesis strategies are generally known in the art. For example, additional details relating to library synthesis using combinatorial and parallel approaches are described in, e.g., Houghten (2000) “Parallel array and mixture-based synthetic combinatorial chemistry: Tools for the next millennium,” Annu. Rev. Pharmacol. Toxicol. 40:273-282, Thompson (2000) “Recent applications of polymer-supported reagents and scavengers in combinatorial, parallel, or multistep synthesis,” Curr. Opin. Chem. Biol. 4:324-337, Bunin et al. (1999) “Application of combinatorial and parallel synthesis to medicinal chemistry,” Annu. Rep. Med. Chem. 34:267-286, and Brooking et al. (1999) “Split-split. A multiple synthesiser approach to efficient automated parallel synthesis, Tetrahedron Lett. 40(7): 1405-1408.

A standard tool for parallel chemistry, including randomization steps in combinatorial protocols, such as split/pool synthesis, is the multiple well reaction vessel that typically includes a collection of tubes or a reaction block bored out with a designated number of reaction wells or holes. These reaction wells are generally fitted with a filter at one end, which allows the individual wells to be employed for solid-liquid separations or other purification processes. The footprint of such reaction blocks typically corresponds to an array of wells in a standard micro-well assay plate or collection block. A series of individually addressable open reactors is generally formed within a reaction block by contacting, e.g., a gasket to the bottom or outlets of the reaction wells. In addition, a series of enclosed reactors is typically made by sealing the top or inlets to the reaction wells with, e.g., another gasket. Sealed reaction wells provide for aggressive agitation of well contents and for the use of extreme reaction conditions.

Preexisting technologies generally require that reaction wells be exposed to the external environment when fluidic materials, such as reagents, solid supports, wash solvents, cleavage solvents, or the like are delivered to or removed from reaction blocks. This practice has significant disadvantages. To illustrate, accessing reaction wells by physically opening and closing reaction blocks is generally the most time consuming step in a given synthesis protocol. However, in addition to limiting throughput, the exposure of reaction well contents to the outside environment subjects the library synthesis procedure to, e.g., the risk of product loss, contamination, and/or otherwise being compromised by exposure to moisture or air. This practice also disrupts the otherwise relatively inert atmosphere within an enclosed reaction well, which may be crucial to the integrity and success of the particular reaction or processing step. Furthermore, cleavage steps typically yield high levels of extractables when solvents leach out of soluble materials, e.g., from polypropylene reaction blocks and gaskets. Accordingly, performing reactions in unsealed reaction wells (i.e., in an open environment) exposes both the internal and external surfaces of, e.g., the reaction block to the outside environment, which leads to increased levels of observed extractables relative to reactions performed in sealed environments.

From the foregoing discussion, it is apparent that there is a substantial need for new parallel reaction devices that permit efficient and rapid access to reaction wells without exposing well contents to the external environment. It would also be desirable to access the reaction wells of multiple reaction blocks from multiple sides, where the reaction blocks remain securely sealed under diverse reaction conditions, including varied extremes of temperature and agitation. These and a variety of additional features of the present invention will become evident upon complete review of the following.

### SUMMARY OF THE INVENTION

The present invention generally relates to devices and methods for distributing or manifolding materials. In particular, the invention relates to devices and methods of moving materials to and/or from selected reaction wells of reaction blocks through multiple reaction block surfaces. Although essentially any material is optionally delivered to and/or removed from the reaction blocks of the invention, liquid-phase materials are distributed in preferred embodiments. The devices and methods of the present invention significantly increase the throughput of various processes, including chemical synthesis procedures, relative to preexisting devices and methods, without exposing the contents of reaction wells to the outside environment. The invention additionally provides systems, reaction block carriers, and other device components.

In one aspect, the invention relates to a manifolding device that includes (a) at least one first material conduit in communication with at least one first container, which first material conduit is capable of removably accessing one or more reaction wells of at least one reaction block through one or more first openings in a first surface of the reaction block to communicate with the reaction wells, and (b) at least one second material conduit in communication with at least one second container, which second material conduit is capable of removably accessing the reaction wells of the reaction block through one or more second openings in a second surface of the reaction block to communicate with the reaction wells. The first and second containers are optionally independently selected from one or more of: solid-phase material containers, liquid-phase material containers, or gaseous-phase material containers. The manifolding device also includes (c) at least one material direction component operably connected to the first material conduit, the second material conduit, or both the first and second material conduits, which material direction component is capable of moving one or more materials (e.g., solid-phase materials, liquid-phase materials, and/or gaseous-phase materials) to or from the reaction wells. For example, the material direction component optionally includes at least one pressure-force modulator capable of selectively applying positive or negative pressure to the first material conduit, the second material conduit, or both the first and second material conduits.

In preferred embodiments, the first and second material conduits each include at least one array of material conduits. For example, the array of material conduits typically includes at least one array of needles. Further, the array of material conduits is generally capable of axially aligning with the reaction wells of the reaction block to access and communicate with the reaction wells. In certain embodiments, the array of material conduits includes multiple arrays of material conduits (e.g., multiple arrays of needles or the like).

In some embodiments, multiple reaction blocks are used. Typically, the multiple reaction blocks are arrayed in a reaction block carrier in which at least one reaction well is accessible by both the first and second material conduits. The multiple reaction blocks are optionally sealed by cap mats, gasketing sheets, or both cap mats and gasketing sheets disposed between a portion of the reaction block carrier and the multiple reaction blocks. The first and second fluid conduits are capable of accessing the multiple reaction blocks by piercing the cap mats, the gasketing sheets, or both the cap mats and the gasketing sheets.

The manifolding devices and systems of the invention also typically include at least one handling system operably connected to one or more of the first material conduit, the second material conduit, or the reaction block to move the first material conduit, the second material conduit, and/or the reaction block relative to one another to effect removable access of the reaction wells by the first material conduit, the second material conduit, or both the first and second material conduits. For example, the handling system is typically capable of applying at least about 30 pounds of pressure per square inch of reaction block surface area accessed by the first or second material conduits.

In another aspect, the present invention relates to a fluid manifolding device that includes (a) at least one first fluid conduit in fluid communication with at least one first fluid container, which first fluid conduit is capable of removably accessing one or more reaction wells of at least one reaction block (e.g., disposed within a reaction block carrier or the like) through one or more first openings in a first surface (e.g., a top surface, etc.) of the reaction block to fluidly communicate with the reaction wells, and (b) at least one second fluid conduit in fluid communication with at least one second fluid container, which second fluid conduit is capable of removably accessing the reaction wells of the reaction block through one or more second openings in a second surface (e.g., a bottom surface, etc.) of the reaction block to fluidly communicate with the reaction wells. The first and/or second fluid conduits generally include at least one needle. The fluid manifolding device also includes (c) at least one fluid direction component operably connected to the first fluid conduit, the second fluid conduit, or both the first and second fluid conduits, which fluid direction component is capable of flowing one or more fluidic materials (including, e.g., solid supports, reagents, reactants, products, buffers, solvents, wash solvents, cleavage solvents, and/or the like) to or from the reaction wells. For example, the fluid direction component optionally includes a pressure force modulator capable of selectively applying positive or negative pressure to the first fluid conduit, the second fluid conduit, or both the first and second fluid conduits.

In preferred embodiments, the first and second fluid conduits each include at least one array of fluid conduits. For example, the array of fluid conduits optionally includes about 6, 12, 24, 48, 96, 384, 1536, or more members in the array of fluid conduits. The array of fluid conduits is typically capable of axially aligning with the reaction wells of the reaction block to access and communicate with the reaction wells. Further, the array of fluid conduits generally includes at least one array of needles. In particular, at least one member of the array of needles typically includes at least one channel disposed at least partially therethrough, which channel includes at least one first opening disposed proximal to a terminus of the needle and at least one second opening disposed along a length of the member. In certain embodiments, the array of fluid conduits includes multiple arrays of fluid conduits (e.g., about 2, 3, 4, 5, 6, 7, 8, 9, 10, or more arrays of fluid conduits).

A reaction block of the present invention generally includes a footprint that corresponds to wells in a micro-well plate. For example, the reaction block optionally includes, e.g., 6, 12, 24, 48, 96, 384, 1536, or more reaction wells. In addition, at least one reaction well optionally further includes a filter disposed therein, e.g., to retain solid supports or other materials within the reaction well. In preferred embodiments, the fluid manifolding device includes multiple reaction blocks (e.g., about 2, 3, 4, 5, 6, 7, 8, 9, 10, or more reaction blocks). The multiple reaction blocks are typically arrayed (e.g., in one or more rows or the like) in at least one reaction block carrier in which at least one reaction well is accessible by both the first and second fluid conduits. In preferred embodiments, each reaction well of the multiple reaction blocks is accessible by both the first and second fluid conduits. The fluid manifolding device generally includes one or more alignment structures, which alignment structures align the reaction block carrier relative to the device. In addition, the multiple reaction blocks are typically sealed by cap mats, gasketing sheets, or both cap mats and gasketing sheets disposed between a portion of the reaction block carrier and the multiple reaction blocks. For example, the first and second fluid conduits are generally capable of accessing the multiple reaction blocks by piercing the cap mats, the gasketing sheets, or both the cap mats and the gasketing sheets. Furthermore, each cap mat typically includes at least one protrusion, which protrusion axially aligns with at least one reaction well, e.g., to seal the reaction well.

The fluid containers of the fluid manifolding devices of the invention include various embodiments. For example, the first fluid container optionally includes, e.g., at least one fluidic material source. The second fluid container optionally includes, e.g., at least one waste container or at least one collection block. Typically, the first and/or second fluid container includes multiple fluid containers.

In still another aspect, the present invention provides a fluid manifolding device that includes (a) at least one first array of needles in fluid communication with at least one first fluid container, which first array of needles is capable of removably accessing reaction wells (e.g., 6, 12, 24, 48, 96, 384, 1536, or more reaction wells) of at least one reaction block through one or more first openings in a first surface (e.g., a top surface or the like) of the reaction block to fluidly communicate with the reaction wells in which the reaction block is disposed in a multiple reaction block carrier, and (b) at least one second array of needles in fluid communication with at least one second fluid container, which second array of needles is capable of removably accessing the reaction wells of the reaction block through one or more second openings in a second surface (e.g., a bottom surface or the like) of the reaction block to fluidly communicate with the reaction wells. The fluid manifolding device typically includes one or more alignment structures, which alignment structures align the reaction block carrier relative to the device. In addition, the fluid manifolding device also includes (c) at least one fluid direction component operably connected to the first array of needles, the second array of needles, or both the first and second arrays of needles, which fluid direction component is capable of flowing one or more fluidic materials to or from the reaction wells.

The present invention also provides a fluid manifolding system that includes (a) at least one reaction block and (b) at least one fluid manifolding device. The fluid manifolding device includes (i) at least one first fluid conduit in fluid communication with at least one first fluid container, which first fluid conduit is capable of removably accessing one or more reaction wells of the reaction block through one or more first openings in a first surface of the reaction block to fluidly communicate with the reaction wells, and (ii) at least one second fluid conduit in fluid communication with at least one second fluid container, which second fluid conduit is capable of removably accessing the reaction wells of the reaction block through one or more second openings in a second surface of the reaction block to fluidly communicate with the reaction wells. The fluid manifolding device also includes (iii) at least one fluid direction component operably connected to the first fluid conduit, the second fluid conduit, or both the first and second fluid conduits, which fluid direction component is capable of flowing one or more fluidic materials to or from the reaction block. In addition, the fluid manifolding system includes (c) at least one computer or other information appliance operably connected to the fluid manifolding device. The computer includes system software which directs the fluid manifolding device to: (i) access the reaction block with the first fluid conduit, the second fluid conduit, or both the first and second fluid conduits to establish fluid communication between the reaction wells and the fluid manifolding device, and (ii) flow one or more fluidic materials to or from the reaction wells through the first fluid conduit, the second fluid conduit, or both the first and second fluid conduits.

The present invention additionally provides methods of fluidly communicating with one or more reaction wells of at least one reaction block. The methods include (a) providing a fluid manifolding device that includes: (i) at least one first fluid conduit in fluid communication with at least one first fluid container, which first fluid conduit is capable of removably accessing the reaction wells of the reaction block through one or more first openings in a first surface (e.g., a top surface or the like) of the reaction block to fluidly communicate with the reaction wells, (ii) at least one second fluid conduit in fluid communication with at least one second fluid container, which second fluid conduit is capable of removably accessing the reaction wells of the reaction block through one or more second openings in a second surface (e.g., a bottom surface or the like) of the reaction block to fluidly communicate with the reaction wells, and (iii) at least one fluid direction component operably connected to the first fluid conduit, the second fluid conduit, or both the first and second fluid conduits, which fluid direction component is capable of flowing one or more fluidic materials to or from the reaction wells. Optionally, the reaction wells further include filters disposed therein. Also, the fluid direction component optionally includes a pressure force modulator capable of selectively applying positive or negative pressure to the first fluid conduit, the second fluid conduit, or both the first and second fluid conduits. The methods also include (b) positioning the reaction block relative to the fluid manifolding device such that the fluid manifolding device is capable of fluidly communicating with the reaction wells, (c) accessing the reaction wells with the first fluid conduit, the second fluid conduit, or both the first and second fluid conduits to establish fluid communication between the reaction wells and the fluid manifolding device, and (d) flowing one or more fluidic materials to or from the reaction wells through the first fluid conduit, the second fluid conduit, or both the first and second fluid conduits, thereby fluidly communicating with the reaction wells. Typically, at least one cap mat seals the reaction wells of the reaction block and (c) includes piercing the cap mat with the first and/or second fluid conduit. Optionally, the methods further include (e) withdrawing the first fluid conduit, the second fluid conduit, or both the first and second fluid conduits from the reaction block. An additional option includes (f) repeating (c)-(e).

The methods of the present invention optionally include performing all or part of various chemical synthesis procedures. For example, the methods optionally further include performing one or more parallel synthesis reactions (e.g., solid-phase synthesis reactions, liquid-phase synthesis reactions, etc.) in the reaction wells of the reaction block prior to (a). In certain embodiments, (d) includes flowing one or more wash solvents through the first fluid conduit into the reaction block to wash solid supports disposed within the reaction wells. In these embodiments, (d) optionally further includes flowing the wash solvents from the reaction block through the second fluid conduit. In other embodiments, (d) includes flowing one or more cleavage solvents through the first fluid conduit into the reaction block to cleave products from solid supports disposed within the reaction wells. In these embodiments, (d) further includes flowing the cleavage solvents, products, and/or solid supports from the reaction block through the second fluid conduit.

In certain embodiments, the reaction wells include filters disposed therein capable of retaining solid supports in the reaction wells and (d) includes: (i) flowing a first fluid including one or more substrates attached to one or more solid supports through the first fluid conduit into the reaction wells of the reaction block, and (ii) flowing a second fluid including one or more first chemical substituents through the first fluid conduit into the reaction wells of the reaction block, which first chemical substituents react with the substrates to produce one or more first products attached to the one or more solid supports. The first and second fluids are typically flowed from different first fluid containers. The methods optionally further include flowing at least a portion of the first and second fluids from the reaction wells prior to (ii) in which the solid supports are retained in the reaction wells by the filters. In some embodiments, the methods also include (iii) flowing one or more wash solvents through the first fluid conduit into the reaction wells to wash the solid supports, and (iv) flowing the wash solvents from the reaction wells through the second fluid conduit. Optionally, the methods also include (v) flowing one or more cleavage solvents through the first fluid conduit into the reaction wells to cleave the first products from the solid supports, and (vi) flowing the first products from the reaction wells through the second fluid conduit. Another option includes (v) flowing a third fluid including one or more second chemical substituents through the first fluid conduit into the reaction wells of the reaction block, which second chemical substituents react with the first products to produce one or more second products attached to the one or more solid supports.

The present invention additionally provides methods of fluidly communicating with one or more wells of at least one reaction block that includes (a) providing a fluid manifolding device that includes (i) at least one first array of needles in fluid communication with at least one first fluid container, which first array of needles is capable of removably accessing the reaction wells of the reaction block through one or more first openings in a first surface of the reaction block to fluidly communicate with the reaction wells, wherein the reaction block is disposed in a reaction block carrier, (ii) at least one second array of needles in fluid communication with at least one second fluid container, which second array of needles is capable of removably accessing the reaction wells of the reaction block through one or more second openings in a second surface of the reaction block to fluidly communicate with the reaction wells, and (iii) at least one fluid direction component operably connected to the first array of needles, the second array of needles, or both the first and second arrays of needles, which fluid direction component is capable of flowing one or more fluidic materials to or from the reaction wells. The methods also include (b) positioning the reaction block relative to the fluid manifolding device such that the fluid manifolding device is capable of fluidly communicating with the reaction wells, (c) accessing the reaction wells of the reaction block with the first array of needles, the second array of needles, or both the first and second arrays of needles to establish fluid communication between the reaction wells and the fluid manifolding device, and (d) flowing one or more fluidic materials to or from the reaction wells of the reaction block through the first array of needles, the second array of needles, or both the first and second array of needles, thereby fluidly communicating with the reaction wells.

### BRIEF DESCRIPTION OF THE DRAWINGS

FIG. 1A schematically depicts one embodiment of a reaction block from a perspective view.

FIG. 1B schematically shows the reaction block of FIG. 1A with reaction wells sealed by cap mats from a cutaway, side elevational view.

FIG. 2A schematically illustrates one embodiment of a reaction block carrier from a perspective view.

FIG. 2B schematically depicts the reaction block carrier of FIG. 2A from a cutaway, side elevational view.

FIG. 3 schematically illustrates one embodiment of a carrier assembly component of a manifolding device of the invention from a front elevational view.

FIG. 4A schematically shows one embodiment of a distribution or fill head manifold component of a fill head assembly of a manifolding device of the invention from a side elevational view.

FIG. 4B schematically depicts the fill head manifold of FIG. 4A from a cutaway of a different side elevational view.

FIG. 4C schematically shows one embodiment of a fill head.

FIG. 5 schematically depicts one embodiment of a needle.

FIG. 6 schematically illustrates one embodiment of a fluid manifolding system from a front elevational view.

FIG. 7 schematically shows another embodiment of a needle.

FIG. 8 schematically depicts certain purification procedures for reactions involving excess solution compounds.

FIG. 9 schematically illustrates a purification process that includes the use of limiting amounts of solid phase compounds.

FIG. 10 schematically shows a purification procedure that includes the use of a support-bound scavenger.

FIG. 11 schematically shows a purification protocol that involves solid support capture.

FIG. 12 schematically illustrates a purification procedure that involves solid supported liquid extraction.

FIG. 13 schematically shows a purification procedure that includes support-bound catalysis.

FIG. 14 schematically shows a synthesis/purification procedure that involves multistep solid-phase synthesis.

### DETAILED DISCUSSION OF THE INVENTION

I. Definitions

Before describing the present invention in detail, it is to be understood that this invention is not limited to particular devices or systems, which can, of course, vary. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which the invention pertains. In describing and claiming the present invention, the following terminology will be used in accordance with the definitions set out below.

An “array” refers to an ordered, regular, or spatially defined pattern, grouping, or arrangement of components. For example, an array of reaction wells in a reaction block includes a spatially defined pattern of reaction wells of essentially any number (e.g., 2, 4, 6, 12, 24, 48, 96, 384, 1536, or more reaction wells). Similarly, an array of conduits (e.g., material or fluid conduits, such as arrays of needles, etc.) includes a spatially defined arrangement of conduits of essentially any number (e.g., 2, 4, 6, 12, 24, 48, 96, 384, 1536, or more conduits). For a given number of reaction wells or other device components (e.g., conduits, needles, apertures, protrusions, or the like), alternative spatial patterns are typically possible. To illustrate, a 48-well reaction block optionally includes an array of 4 rows by 12 columns of wells (i.e., a 4×12 array), a 6×8 array, or the like. In certain embodiments, arrays of, e.g., reaction wells, conduits, needles, apertures, protrusions, or the like have footprints that correspond to arrays of wells in commercially available micro-well plates or other sample containers (e.g., 6 wells in a 3×2 array, 12 wells in 3×4 array, 24 wells in a 6×4 array, 48 wells in a 6×8 array, 96 wells in a 8×12 array, or the like).

A “footprint” refers to the area on a surface covered by or corresponding to a device component or portions thereof. For example, openings to reaction wells of a reaction block of the invention typically correspond to (e.g., fit into, match, align with, etc.) wells in a selected micro-well plate or other sample container. The correspondence is typically one-to-one (e.g., one reaction well per each well in a micro-well plate, one needle in an array per each reaction well in a reaction block, etc.), but is also optionally otherwise (e.g., multiple reaction wells per each well in a micro-well plate, multiple needles in an array per each reaction well in a reaction block, etc.). In preferred embodiments of the invention, device components (e.g., reaction wells, conduits, needles, apertures, protrusions, etc.) and wells of micro-well plates have substantially the same footprint, such that they axially align with one another (e.g., for fluid communication with respect to reaction wells and apertures or wells of micro-well plates or collection blocks).

The term “top” refers to the highest point, level, surface, or part of a device, or device component, when oriented for typical designed or intended operational use, such as dispensing a fluidic material into a reaction well. For example, the reaction blocks of the invention generally include a top surface through which first fluid conduits (e.g., arrays of needles, etc.) access fluidic materials within reaction wells of the blocks. In contrast, the term “bottom” refers to the lowest point, level, surface, or part of a device, or device component, when oriented for typical designed or intended operational use. To illustrate, the reaction blocks of the invention typically include a bottom surface through which second fluid conduits (e.g., arrays of needles, etc.) access fluidic materials within reaction wells of the blocks.

The phrase “substantially even clamp load or force” refers to an applied force that is approximately uniformly distributed across a contact surface towards which the force is directed. For example, when reaction wells are sealed in a reaction block carrier of the present invention, the force applied by a portion of a support structure of the carrier that engages a reaction block (e.g., through a cap mat, a sheet of gasketing material, and/or the like) is substantially the same at, e.g., any two points of contact with the reaction block (e.g., at any two openings of reaction wells, or the like).

The term “engages” refers to the bringing or coming together, interlocking, or meshing of device components. To illustrate, when reaction wells of reaction blocks are sealed within reaction block carriers, portions of the support structures of the reaction block carriers are brought together with the reaction blocks, e.g., with cap mats and/or sheets of gasketing material disposed therebetween.

The word “manifolding” refers to the distribution of materials (e.g., solid-phase materials, liquid-phase materials, and/or gas-phase materials) to and/or from selected reaction wells of the reaction blocks of the invention. In preferred embodiments, for example, fluidic materials are optionally flowed to and/or from selected reaction wells in reaction blocks through one or more selected fluid conduits, e.g., from and/or to one or more fluid containers (e.g., reagent containers, wash solvent containers cleavage solvent containers, collection blocks, micro-well plates, or the like).

The phrase “radial seal” refers to the closure of a reaction well that is substantially uniform around a central axis, which seal secures the well against leakage.

II. Devices, Systems, and Methods

The present invention generally relates to devices, systems, and methods for simultaneously performing various chemical, biological, purification, and/or other processes with significantly improved throughput relative to preexisting technologies. In particular, the invention provides devices, systems, and methods for distributing materials to and/or from the reaction wells of multiple reaction blocks. More specifically, the invention includes reaction block carriers that permit users to rapidly, easily, and securely seal or unseal multiple reaction blocks simultaneously. Reaction block carriers are typically positioned in manifolding devices or systems that include multiple material conduits that are capable of removably accessing reaction wells within sealed reaction blocks through different surfaces of the reaction blocks. In preferred embodiments, the material conduits include arrays of needles (e.g., multiple arrays of needles, etc.). For example, a first set of arrays of needles typically pierce cap mats, gaskets, and/or other reaction block sealing materials to access reaction wells through a top surface of the reaction blocks in order to dispense and/or withdraw materials from the reaction wells. Similarly, a second set of arrays of needles typically accesses the reaction wells of the reaction blocks in the reaction block carrier by piercing sealing materials that seal the reaction wells from other sides (e.g., through bottom surfaces) of the reaction blocks to dispense and/or withdraw materials from the reaction wells. The sets of arrays of needles of the invention typically pierce reaction well sealing materials using handling systems that include one or more actuators operably connected to the arrays of needles and/or reaction block carries. The actuators are capable of applying significant amounts of pressure or loads, e.g., to force each member of an array of needles, or a set of arrays of needles, through sealing materials and into reaction wells.

The invention is optionally utilized to perform a diverse range of parallel, combinatorial, and/or other synthesis procedures, or portions of such procedures, which involve adding reagents or other components to the individual reaction wells of reaction blocks to effect chemical transformations, product purifications, or the like. These include both solution-phase and solid-phase reaction strategies. To illustrate, in certain embodiments, the devices and systems described herein are dedicated solely to solid support washing in individual or multiple blocks. In other embodiments, these devices and systems are dedicated cleavage stations, e.g., of products from solid supports utilized in multiple reaction steps. For example, a key step of many library synthesis protocols that use, e.g., encoded directed sorting, is the final cleavage step in which reaction products are arrayed in parallel in multiple reaction wells. Further, in tandem with cleavage steps it is possible to employ a number of purification strategies such as solid-liquid extraction, covalent scavenging, or the like in the devices and systems of the invention to remove impurities. Various product purification procedures that are optionally performed using the devices described herein are exemplified below. Furthermore, when employing solvent handling tools of the invention, e.g., to add reagents to individual reaction wells or chambers, the devices and systems described herein are optionally used for multi-step reaction sequences.

By treating individual reaction blocks as a set, difficult and time consuming steps, such as solid support plating, reagent addition, block transport, solid support washing, final product cleavage, final product isolation, or the like can be performed at one time in multiple reaction wells of multiple reaction blocks in a high throughput manner, e.g., with automation. This significantly improves throughput, e.g., relative to addressing reaction wells and/or reaction blocks individually. Further, addressing multiple reaction blocks in a reaction block carrier simultaneously also simplifies these processes for users, who would otherwise need to track the reaction blocks individually at any one time.

Additional advantages of the present invention include permitting access to reaction blocks through multiple surfaces without exposing reaction well contents to the outside environment with the attendant risks of contamination, loss of reaction well contents, or the like. This is particularly advantageous when inert reaction conditions (e.g., free from exposure to air, moisture, etc.) within reaction wells are critical to the reaction or processing steps. The use of sealed reaction wells throughout a given procedure also saves significant amounts of time, which would otherwise be allocated to opening and closing the reaction wells. In addition, lower levels of extractables from the reaction blocks and/or sealing materials are observed (e.g., during cleavage steps or the like) using sealed reaction wells, because less reaction block surface area is exposed to the solvent atmosphere. Furthermore, compound isolation or purification steps are performed without opening the blocks to the external environment, such that the contents of multiple blocks can be withdrawn into collection blocks, e.g., with multiple washes applied to the reaction well contents to provide good yields of products with significantly reduced risk of product loss.

The reaction blocks of the present invention generally include arrays of reaction wells in which at least one reaction well in a given array is disposed (e.g., vertically disposed) through the particular reaction block. While in preferred embodiments all reaction wells are disposed completely through a reaction block, in other embodiments, fewer than all wells in an array are disposed completely through a reaction block. Further, reaction blocks are sometimes disposable components of the manifolding devices and systems of the present invention, whereas other components, such as reaction block carriers or the like are typically intended to be used indefinitely. The reaction blocks of the invention also include many alternative arrays of reaction wells and are fabricated from assorted materials or combinations of materials. Reaction blocks suitable for use in the devices, systems, and methods of the present invention are also described in, e.g., U.S. Ser. No. 09/947,236 entitled “PARALLEL REACTION DEVICES,” by Micklash II et al., filed Sep. 5, 2001, which is incorporated by reference in its entirety for all purposes. Additional details regarding reaction blocks and other system components that are optionally used in the devices of the present invention, including those that provide for molecular tracking and identification are described in, e.g., U.S. Pat. No. 6,136,274, entitled “MATRICES WITH MEMORIES IN AUTOMATED DRUG DISCOVERY AND UNITS THEREFOR,” to Nova et al., issued Oct. 24, 2000, which is incorporated by reference in its entirety for all purposes.

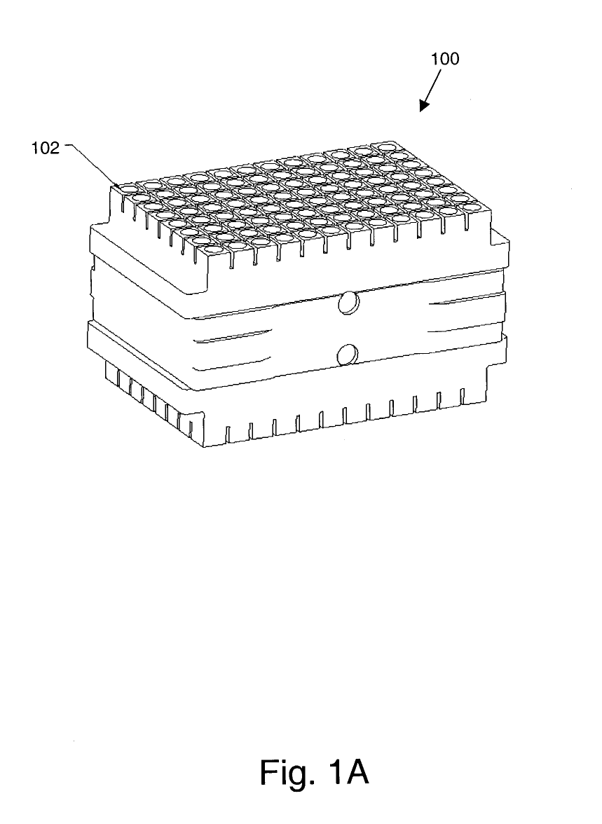

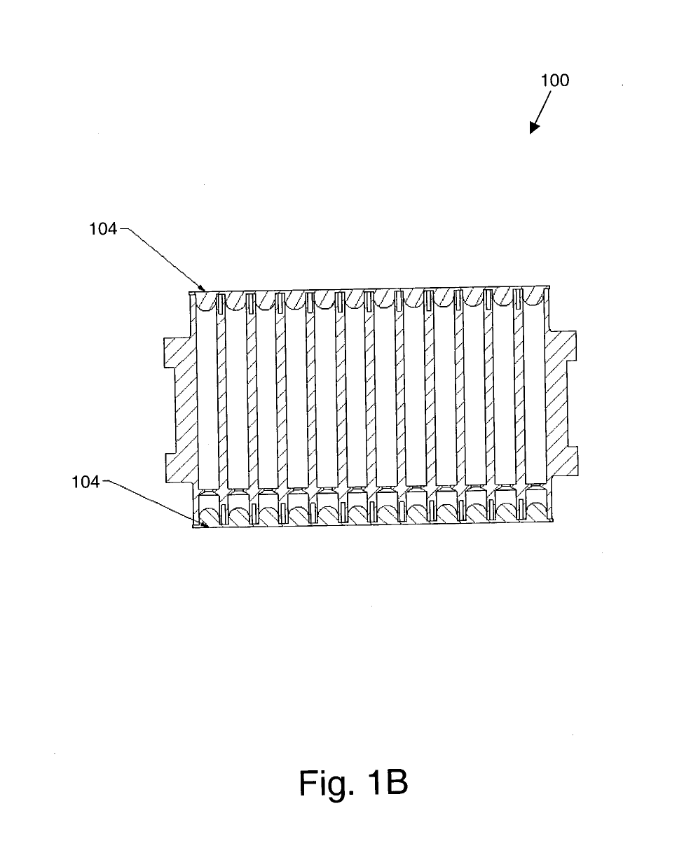

FIG. 1A schematically depicts one embodiment of a reaction block from a perspective view. As shown, reaction block 100 includes an array of 96 reaction wells in which each reaction well 102 is disposed completely through reaction block 100. FIG. 1B schematically shows the array of reaction wells of reaction block 100 sealed with cap mats 104 from a cutaway, side elevational view. Cap mats 104 are sealing devices that are fabricated with multiple plugs or protrusions in which individual plugs are compressed into corresponding or mating reaction wells on reaction block 100. As shown, the array of reaction wells sealed with cap mats 104 form closed reaction wells. Cap mats and other reaction well sealing materials are described in further detail below.

The reaction blocks of the present invention optionally include various numbers and arrays of reaction wells. For example, in certain embodiments reaction blocks include, e.g., 6, 12, 24, 48, 96, 384, 1536, or other numbers of reaction wells. As shown in FIG. 1A, for example, reaction block 100 includes 96 reaction wells arrayed in a rectangular 8×12 format. In preferred embodiments, reaction well openings (e.g., inlet portions, outlet portions, etc.) have footprints that correspond to wells in a micro-well plate, collection block, or other sample container (e.g., plates having 6, 12, 24, 48, 96, 384, 1536, or other numbers of wells). For example, reaction well openings of reaction blocks are optionally spaced at regular intervals, such as 9 mm centers for 96 well plates, 4.5 mm centers for 384 well plates, 2.25 mm centers for 1536 well plates, or the like. The overall dimensional area of a reaction block generally provide a footprint of about the same size as a selected standard micro-well plate to permit optional interchangeable use of the reaction block with standard equipment holders, automated well washers, X-Y-Z translational devices, or the like. It will be appreciated that the present invention may use any of a variety of arrays other than the format depicted in, e.g., FIG. 1A, such as non-rectangular arrays of reaction wells.

Reaction well dimensions (e.g., internal length or height, cross-sectional dimension/area, or the like) are typically selected according to, e.g., the volume of fluidic material desired for containment within a particular well. For example, reaction wells of the present invention generally include volume capacities of between about 0.1 ml and about 100 ml, typically between about 1 ml and about 50 ml, more typically between about 1 ml and about 25 ml, and still more typically between about 1 ml and about 2 ml. Optionally, reaction blocks are designed to accommodate fluid volumes in excess of about 100 ml. In certain embodiments, different reaction wells in a given reaction block include different fluid volume capacities. In preferred embodiments, each well in a reaction block includes about the same fluid volume capacity. Additional reaction well configurations, e.g., which effectively increase individual well volumes without altering reaction block footprints, that are optionally adapted to the reaction blocks of the present invention are described in, e.g., U.S. Pat. No. 6,054,100, entitled “APPARATUS FOR MULTI-WELL MICROSCALE SYNTHESIS,” to Stanchfield et al., issued Apr. 25, 2000, which is incorporated by reference in its entirety for all purposes.

A reaction well, or a portion thereof, optionally includes uniform inner or outer cross-sectional dimensions. However, at least two regions of a particular reaction well typically include different inner or outer cross-sectional dimensions. For example, in preferred embodiments, at least a portion of a reaction well is formed with a smaller inner cross-sectional dimension than other regions of the reaction well, e.g., to produce an internal transitional area. In these embodiments, internal transitional areas proximal to, e.g., openings and other regions within a reaction well are abrupt or gradual (e.g., tapered, incremental, stepped, or the like). These transitional areas optionally serve as a seat for a filter, which is used, e.g., in certain solid-phase synthesis reactions, purification processes, or the like. Filters are described further below. Although schematically depicted in, e.g., FIG. 1A as having a substantially cylindrical shape (i.e., a circular cross-section), reaction wells of the present invention optionally include other cross-sectional shapes. To illustrate, at least a segment of a reaction well optionally includes an inner and an outer cross-sectional shape independently selected from, e.g., a regular n-sided polygon, an irregular n-sided polygon, a triangle, a square, a rounded square, a rectangle, a rounded rectangle, a trapezoid, a circle, an oval, or the like. Rounded internal reaction well surfaces are generally preferred to reduce undesirable fluid wicking which typically occurs with angled internal well surfaces.

Filters are typically utilized in the reaction blocks of the present invention, e.g., to retain solid supports within reaction wells (e.g., during various solid-phase synthesis protocols, etc.) and/or to filter fluidic materials (e.g., when eluting solvents or other solution components from solid supports during various post-reaction work-up procedures). Examples of work-up or purification procedures optionally performed in the device and systems of the invention are provided below. Filters generally have shapes corresponding to inner cross-sectional shapes of reaction wells and are typically press fitted into reaction wells, such that they are seated proximal to, e.g., transitional areas of reaction wells. Essentially any material, e.g., capable of retaining the selected solid support size in the reaction well is optionally used as a filter in the devices of the invention. In preferred embodiments, the filters are frits of glass or plastic. For example, in certain embodiments, filters include semi-permeable membranes that retain material based upon size. Suitable semi-permeable membrane materials generally include a pore size of at least about 1 nm. For example, semi-permeable membrane materials optionally utilized in the devices of the invention includes pore sizes of between about 1 μm and about 100 μm, typically between about 5 μm and about 50 μm, and more typically between about 10 μm and about 25 μm.

More specifically, suitable semi-permeable membrane materials are optionally selected from, e.g. polyaramide membranes, polycarbonate membranes, porous plastic matrix membranes (e.g., POREX® Porous Plastic, etc.), porous metal matrix membranes, polyethylene membranes, poly(vinylidene difluoride) membranes, polyamide membranes, nylon membranes, ceramic membranes, polyester membranes, polytetrafluoroethylene (TEFLON®) membranes, woven mesh membranes, microfiltration membranes, nanofiltration membranes, ultrafiltration membranes, dialysis membranes, composite membranes, hydrophilic membranes, hydrophobic membranes, polymer-based membranes, non-polymer-based membranes, powdered activated carbon membranes, polypropylene membranes, glass fiber membranes, glass membranes, nitrocellulose membranes, cellulose membranes, cellulose nitrate membranes, cellulose acetate membranes, polysulfone membranes, polyethersulfone membranes, polyolefin membranes, or the like. Filters (e.g., semi-permeable membrane materials) optionally used in the present invention are widely available from various commercial suppliers, such as, P. J. Cobert Associates, Inc. (St. Louis, Mo.), Millipore Corporation (Bedford, Mass.), or the like. Additional details regarding filtration and membranes are described in various publications including, e.g., Ho and Sirkar (Eds.), Membrane Handbook, Van Nostrand Reinhold (1992), Cheryan, Ultrafiltration and Microfiltration Handbook, 2^{nd} Ed., Technomic Publishing Company (1998), and Mulder, Basic Principles of Membrane Technology, 2^{nd} Ed., Dordrecht: Kluwer (1996).

Reaction blocks of the present invention are typically fabricated as single integral units. Optionally, reaction blocks are assembled from individually fabricated component parts (e.g., individual reaction wells, etc). Reaction block fabrication materials or substrates are generally selected according to properties, such as reaction inertness, durability, expense, or the like. In preferred embodiments, reaction blocks, or components thereof, are fabricated from various polymeric materials such as, polytetrafluoroethylene (TEFLON®), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords reaction block disposability (i.e., replacing the reaction block without replacing other device components, such as reaction block carriers or the like). Reaction blocks or component parts are also optionally fabricated from other materials including, e.g., glass, metal (e.g., stainless steel, anodized aluminum, etc.), silicon, or the like. For example, reaction blocks are optionally assembled from a combination of materials permanently or removably joined or fitted together, e.g., polymer or glass reaction wells with a stainless steel frame to position the reaction wells relative to one another.

The reaction blocks or reaction block components are optionally formed by various fabrication techniques or combinations of such techniques including, e.g., injection molding, cast molding, machining, embossing, extrusion, etching, or other techniques. These and other suitable fabrication techniques are generally known in the art and described in, e.g., Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). After reaction block fabrication, reaction blocks or components thereof, such as reaction wells, are optionally further processed, e.g., by coating surfaces with, e.g., a hydrophilic coating, a hydrophobic coating, or the like.

To effectively seal the reaction wells in the devices of the present invention, cap mats and/or gaskets (e.g., sheets of gasketing material, etc.) are generally disposed between support structures of reaction block carriers and the reaction blocks. Cap mats and gaskets are sometimes disposable or consumable components of the devices of the invention. In particular, cap mats and gasket sheets suitable for use in the devices of the present invention are optionally made from essentially any chemically resistant rubber or elastomeric material, many of which are well known in the art. For example, suitable cap mats and gasket sheets are optionally fabricated from, e.g., Viton®, Santoprene®, Teflon®, Gore-Tex®, Celerus™, or the like. Many of these materials are readily available from various commercial suppliers, such as W. L. Gore & Associates (Newark, Del.). In preferred embodiments, cap mats are fabricated from silicon and are optionally coated with Teflon® and/or with another chemically resistant material. Combinations of materials, e.g., in the form of laminates are also optionally utilized as cap mats and gasketing sheets in the devices of the invention. Cap mats and gasket materials are also typically selected based upon abilities to maintain seals without leakage of fluidic materials even after sustaining repeated punctures and withdrawals of syringe needles. In certain embodiments, multiple gasket sheets (e.g., 2, 3, 4, etc.) are disposed between reaction block support structures reaction block surfaces.

A cap mat is typically fabricated as a sheet of flexible material that includes an array of protrusions disposed on at least one surface of the sheet of flexible material, which array of protrusions is capable of axially aligning with an array of reaction wells disposed in or through a reaction block to seal the reaction wells. Such protrusions are included to further effect radial seals of reaction wells in the reaction blocks of the invention. Cap mats 104 of FIG. 1B schematically illustrate portions of arrays of protrusions that correspond to reaction wells in a 96-well reaction block.

One method of sealing reaction wells in one or more reaction blocks includes (a) providing a multiple reaction block carrier including a support structure, which support structure is capable of laterally arraying and sealing two or more reaction blocks in substantially fixed positions relative to the support structure, and (b) providing at least one reaction block including an array of reaction wells disposed through the reaction block. The methods also include (c) positioning an array of protrusions of a first cap mat in openings to the array of reaction wells disposed on a first surface of the reaction block of step (b) and an array of protrusions of a second cap mat in openings to the array of reaction wells disposed on a second surface of the reaction block of step (b), and (d) positioning the reaction block of step (c) in the multiple reaction block carrier of step (a), thereby sealing the reaction wells in the reaction block. Optionally, the methods also include positioning a first gasketing sheet over the first cap mat and a second gasketing sheet over the second cap mat prior to step (d). The first and second gasketing sheets further seal the reaction wells.

A reaction block carrier of the present invention typically includes a support structure, which support structure is capable of laterally arraying (e.g., in one or more rows, etc.) and sealing two or more reaction blocks (e.g., about 3, 4, 5, 6, 7, 8, 9, 10, or more reaction blocks) in substantially fixed positions relative to the support structure in which at least one reaction well of at least one reaction block is accessible. In preferred embodiments, each reaction well of reaction blocks disposed within a reaction block carrier is accessible by one or more needles through multiple surfaces of the reaction blocks.

The support structure of the reaction block carrier generally includes a top portion attached to a bottom portion by at least one attachment component (e.g., at least one hinge, at least one latch, at least one hinge and at least one latch, or the like) in which the reaction blocks are disposed within the support structure. Optionally, the top portion is removably attached to the bottom portion. In some embodiments, the support structure also optionally includes at least one handle. In addition, the top and bottom portions each typically include at least one alignment structure, which alignment structure aligns the reaction blocks relative to the support structure or the support structure relative to a fluid manifolding device. Reaction block carrier components are typically fabricated from various durable materials including, e.g., metallic materials (e.g., steel, stainless steel, anodized aluminum alloys, etc.) or certain polymeric materials. Generally, any sturdy, non-corrosive material suitable for laboratory conditions may be employed. Furthermore, reaction block carriers are typically fabricated utilizing various well-known techniques, such as injection molding, cast molding, machining, or the like.

The top and bottom portions generally include one or more arrays of apertures disposed through the top and bottom portions in which at least one aperture axially aligns with a reaction well in a reaction block disposed within the reaction block carrier. Typically, each aperture in an array axially aligns with a reaction well of a reaction block in the carrier. Apertures are generally tapered, e.g., to guide or otherwise facilitate the entry of needles into reaction wells of a reaction block. Optionally, the top portion, the bottom portion, or both the top and bottom portions include at least one protrusion disposed on a surface that engages the reaction blocks, which protrusion further presses the cap mat into contact with an opening to a reaction well of the reaction block to seal the reaction well. For example, the protrusions optionally include protruding annular ridges disposed around each aperture in an array of apertures. In an assembled reaction block carrier, protruding annular ridges press cap mats and gaskets into contact with openings to reaction wells to radially seal the wells. The radial seals produced by protruding annular ridges prevent leakage of fluidic materials from the reaction wells, e.g., to reduce cross-contamination among reaction wells. These protrusions typically extend between about 0.5 mm and about 5 mm from a surface of the top or bottom portion of a reaction block carrier, and more typically between about 1 mm and about 3 mm from a surface of the top or bottom portion of a reaction block carrier. The use of protrusion to further effect the radial sealing of reaction wells is also described in, e.g., U.S. Ser. No. 09/947,236 entitled “PARALLEL REACTION DEVICES,” by Micklash II et al., filed Sep. 5, 2001, which is incorporated by reference in its entirety for all purposes.

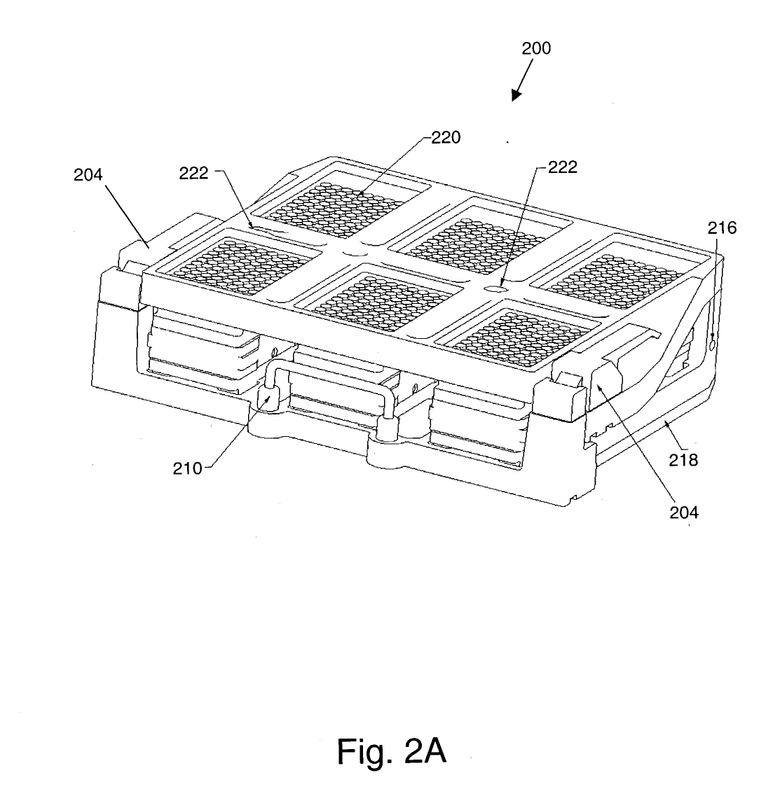

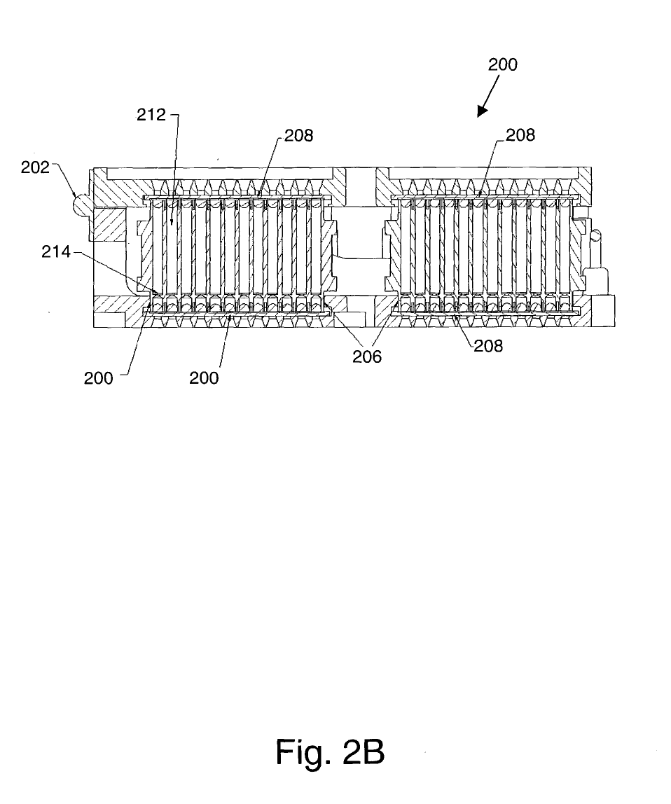

FIG. 2A schematically illustrates one embodiment of a reaction block carrier from a perspective view. FIG. 2B schematically depicts the reaction block carrier of FIG. 2A from a cutaway, side elevational view. As shown, reaction block carrier 200 is designed to hold multiple reaction blocks. In the embodiment depicted in FIG. 2, six reaction blocks are held within one carrier. Optionally, reaction block carriers are designed to hold different numbers of reaction blocks. Reaction block carrier 200 includes hinge 202 in a back portion of reaction block carrier 200 and two latches 204 to apply a substantially even clamp load or force to the top and bottom surfaces of reaction blocks disposed within reaction block carrier 200. Reaction blocks are generally placed into reaction block carrier 200 and positioned using alignment features 206 manufactured into reaction block carrier 200. Gaskets 208 (e.g., fabricated from Viton® or the like) are typically placed on top and bottom surfaces of the reaction blocks over cap mats, which seal the reaction wells of the reaction blocks. Gaskets 208 are compressed between reaction block carrier 200 and the reaction blocks when latches 204 are closed. Gaskets 208 are used to hold the reaction blocks in place and to provide a secondary seal for the reaction wells. Handle 210 is optionally included on reaction block carrier 200, e.g., for ease of transport.

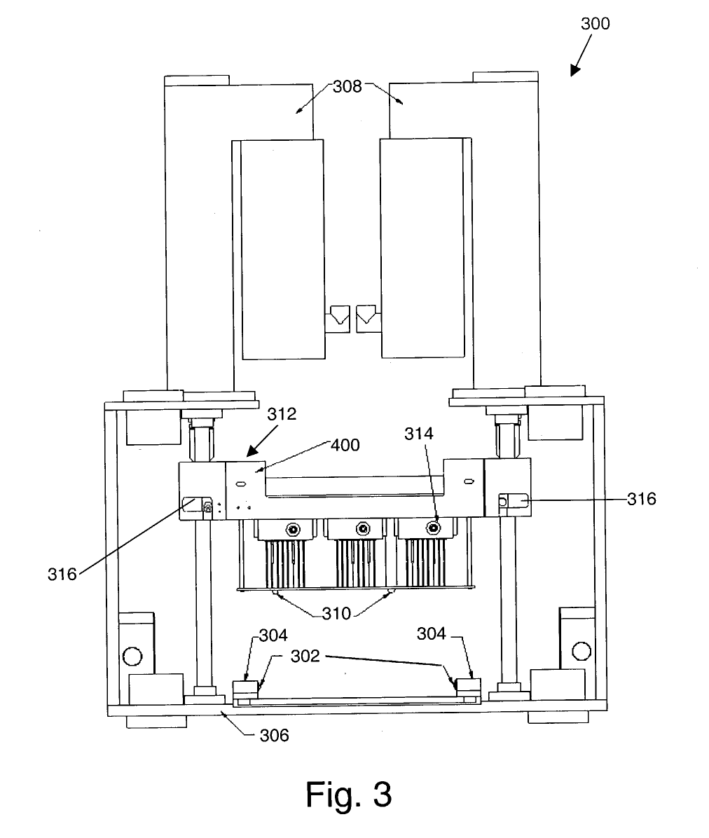

FIG. 3 schematically illustrates one embodiment of a carrier assembly component of a fluid manifolding device or system of the invention from a front elevational view. Referring also to FIGS. 2A and B, which were introduced above, in certain embodiments of the invention, e.g., when synthesis reactions are to be completed and/or various processing steps (e.g., solid support washing, product cleavage, product purification, etc.) are to be performed, reaction block carrier 200 is slid into carrier assembly 300 of the manifolding device or system until reaction block carrier 200 is located using two spring/hall detents 302. Detents 302 locate reaction block carrier 200 using, e.g., spherical features 216 cut into, e.g., two sides of reaction block carrier 200. Further, reaction block carrier 200 is prevented from moving vertically by stops 304 attached to the base plate 306 of carrier assembly 300 that mate with fins 218 cut into reaction block carrier 200. Other mechanisms of various shapes for locating reaction block carriers relative to manifolding devices or systems are also optionally utilized.

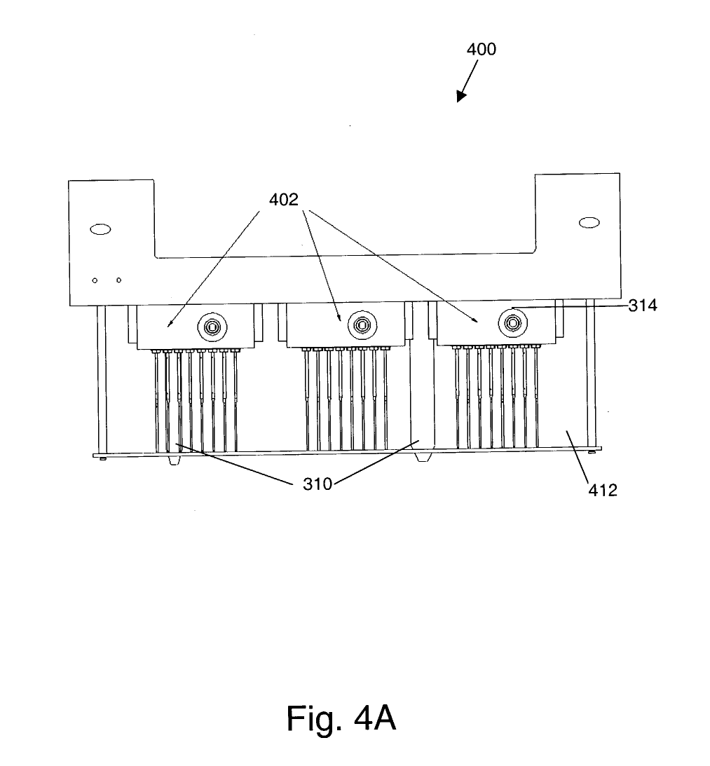

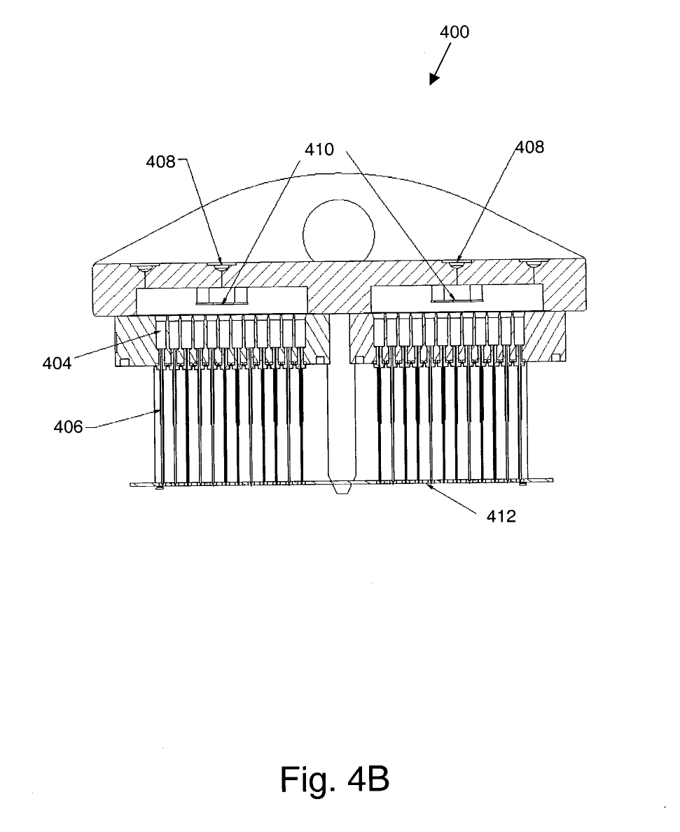

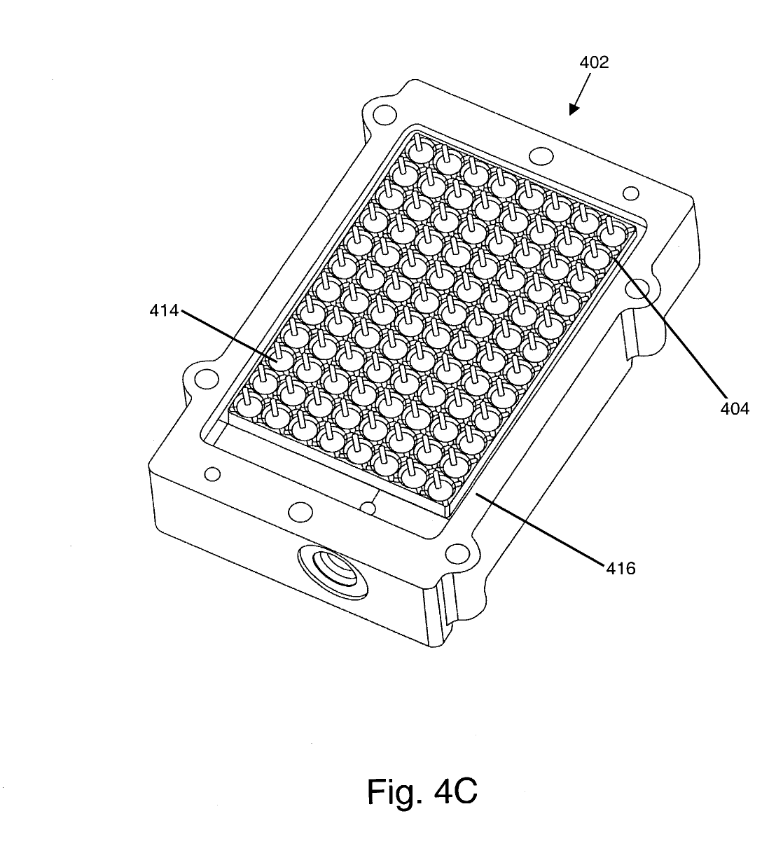

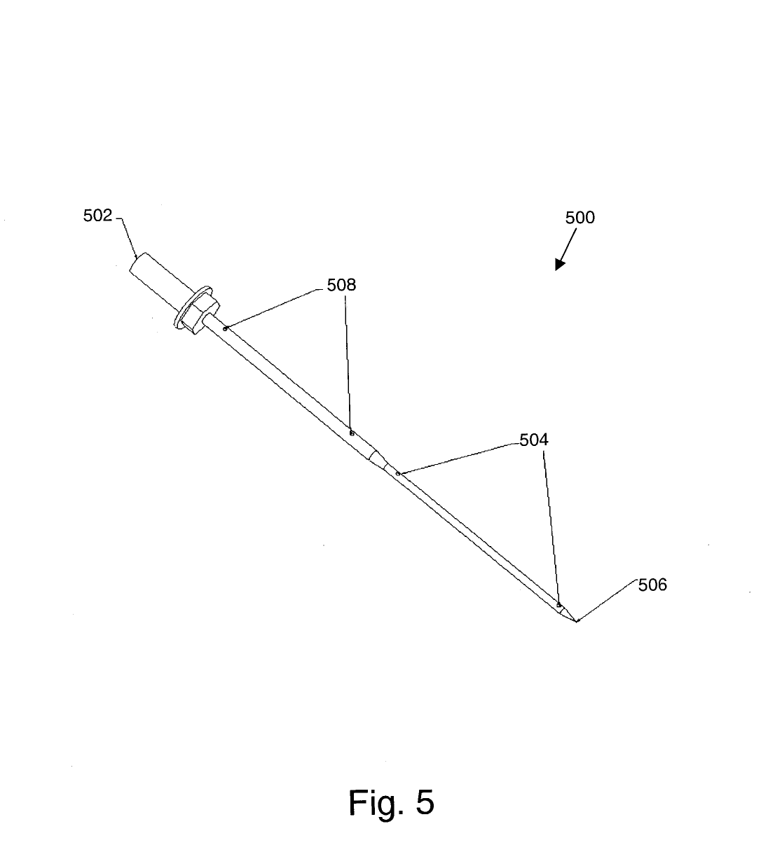

Now additionally referring to FIGS. 4A and B. FIG. 4A schematically shows one embodiment of a distribution or fill head manifold component of a fill head assembly of a fluid manifolding device or system from a side elevational view. FIG. 4B schematically depicts the fill head manifold of FIG. 4A from a cutaway of another side elevational view. For example, before the solid support is, e.g., washed, two actuators 308, which form at least part of the handling system of the invention, move fill head assembly 312 into position. Handling systems are described in further detail below. In certain embodiments, only a single actuator is used to move fill head assembly 312, whereas in others more than two actuators are used. Fill head assembly 312 is made up of multiple fill heads 402 (e.g., typically the same number as the number of reaction blocks in a reaction block carrier at capacity). Each fill head 402 includes multiple wells 404 (e.g., typically the same number as the number of reaction wells in the reaction blocks). Each needle of arrays of fill needles 406 is typically threaded into the bottom of each well 404 and sealed with, e.g., an o-ring (e.g., a Teflon® o-ring, etc.). FIG. 5 schematically depicts one embodiment of a single fill needle. As shown, fill needle 500 includes inlet 502, outlets 504, pencil point tip 506, and vents 508 that are located, e.g., coaxially on the outside of fill needle 500. As actuators 308 move fill head assembly 312 down, arrays of fill needles 406 pass through openings or apertures 220 in reaction block carrier 200 and pierce gaskets 208 and cap mats 104 sealing each reaction block 100. Before needles in the arrays of fill needles 406 actually pierce gaskets 208, locator pins 310 mounted on distribution or fill head manifold 400 pass through mating features 222 in reaction block carrier 200 and align reaction block carrier 200 with fill head assembly 312 more accurately. Fill head assembly 312 is in position when both fill needle outlets of the needles in arrays of fill needles 406 (see, e.g., FIG. 5) have passed through cap mats 104.

Although not shown, lines (e.g., Teflon® lines, etc.) attach each individual fill head 402 to an electrically activated solenoid valve. Lines coming from each solenoid valve meet in fill head manifold 400. Fill head manifold 400 is connected by lines (e.g., Teflon® lines or the like) to a pump, e.g., which forms at least part of the fluid direction component of the invention. In preferred embodiments, the pump is an all Teflon® and stainless steel gear pump. Various fluid containers typically fluidly communicate with the pump. In certain embodiments, for example, six wash solvents feed this solvent pump. In these embodiments, the wash solvents are routed to the solvent pump through lines (e.g., Teflon® lines, etc.) that first pass through electrically activated solenoid valves and then meet in a solvent manifold. This solvent manifold connects a line from, e.g., each solvent bottle to the pump.

The handling systems of the present invention generally include at least one actuator operably connected to one or more of at least a first array of needles, at least a second array of needles, or at least one reaction block. The actuator is capable of moving the first array of needles, the second array of needles, and/or the reaction block relative to one another to effect removable access of reaction wells disposed within the reaction block by the first array of needles, the second array of needles, or both the first and second arrays of needles. In certain embodiments, multiple actuators are used in the handling system. The actuator is typically capable of applying at least about five pounds of pressure per needle or, e.g., at least about 30 pounds of pressure per square inch of reaction block surface area accessed by the first array of needles or the second array of needles. Further, the first and second arrays of needles generally substantially oppose one another. In preferred embodiments, the first and second arrays of needles access the reaction wells through different surfaces of the reaction block. In some embodiments, each of the first and second arrays of needles includes multiple arrays of needles. In addition, the reaction wells disposed within the reaction block are typically sealed by cap mats, gasketing sheets, or both cap mats and gasketing sheets. In these embodiments, the first array of needles, the second array of needles, or both the first and second arrays of needles access the reaction wells by, e.g., piercing the cap mats, the gasketing sheets, or both the cap mats and gasketing sheets. In preferred embodiments, multiple reaction blocks are used in the handling system. For example, the multiple reaction blocks are generally arrayed and sealed in a reaction block carrier.

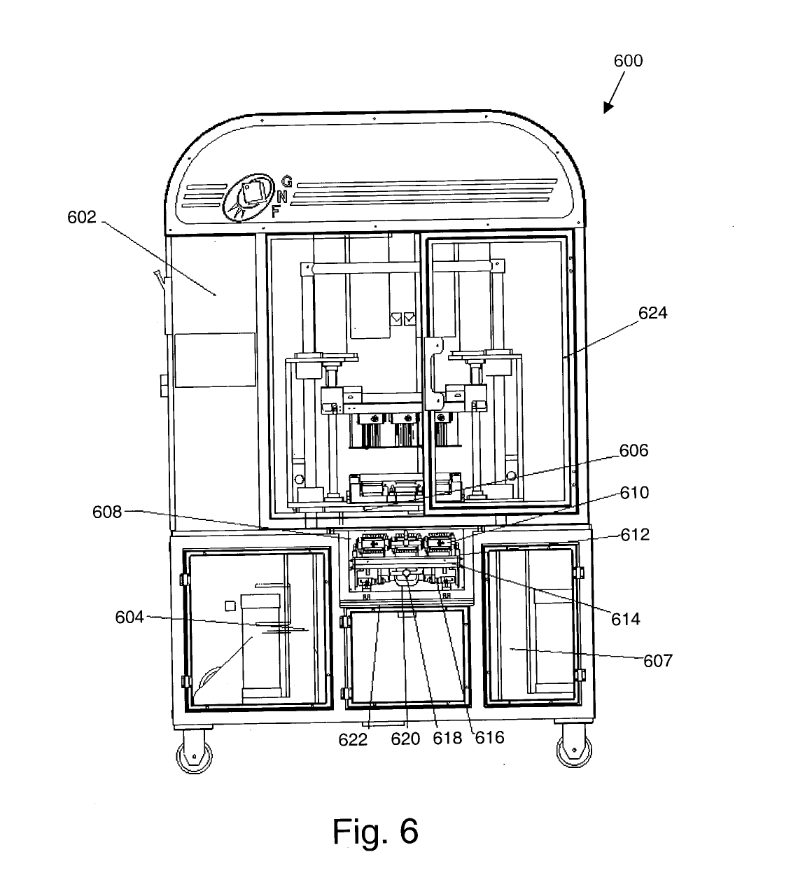

Now with reference to FIG. 6, which schematically illustrates one embodiment of a fluid manifolding system from a front elevational view. For example, solid support washing typically begins when the solvent pump starts drawing the user-defined wash solvent into chosen fill heads 402. The user selects these options by using touch screen 602 mounted on the front of fluid manifolding system 600. Touch screen 602 is operably connected to at least one computer that is typically disposed in fluid manifolding system 600. A variety of options are available for the user to control allowing the proper wash sequence to be performed for a given chemistry. An excess of solvent is pumped into each selected fill head 402. Because the lower openings for fill needle coaxial vents (see, e.g., FIG. 5) have not passed through cap mats 104 on the upper surfaces of the reaction blocks, each reaction well 212 stays pressurized. This allows fill head wells 404 to be filled without solvent leaking out of the fill needles and into reaction wells 212. An electrically actuated valve then opens, and vacuum is applied to fill heads 402. The vacuum then removes solvent through a waste port 314 in each fill head until the solvent level is equal to the top of fill head wells 404. As further shown in the embodiment of fill head 402 schematically depicted in FIG. 4C, fluid flow features 414 are optionally fabricated in a surface of fill head 402 proximal to fill head wells 404. Fluid flow features 414 aid fluid flow into fill head wells 404 especially when the fluid to be dispensed has a high surface tension (e.g., water or the like). In particular, fluid flow features 414 assist in dissipating fluid films and in ensuring that each fill head well 404 in fill head 402 is filled evenly. In addition, fluid channel 416 is optionally fabricated around fill head wells 404, e.g., to minimize fluid wicking or edge effects. Once the proper fluid level has been achieved, the vacuum valve is closed.

In preferred embodiments, the vacuum used for this manifolding system is created by an oil-free all Teflon® vacuum pump. A programmable logic controller (PLC) control system is typically used to control the pump operation. At least two waste containers fluidly communicate with the line connecting the vacuum pump to the device. An electrically actuated solenoid valve selects the waste container to which solvent is fed. A scale is located under each waste container to detect the fluid level for the waste containers. For example, when a first container reaches a specified weight, the solenoid valve will direct waste solvent to a second container. The user is alerted when a waste container is full. The user can also direct the device to use a particular waste container. This feature may be used, e.g., if one system solvent is not compatible with another. In addition, two cold traps and an acid trap are typically also placed in series between the waste containers and the vacuum pump. These traps protect the vacuum pump from damage caused by solvent vapor. Additional details relating to waste solvent handling systems that include scales are provided in, e.g., Attorney Docket No. 36-002700US, entitled “FLUID HANDLING METHODS AND SYSTEMS,” filed Jan. 24, 2003 by Micklash II et al. and Attorney Docket No. 36-002700PC, entitled “FLUID HANDLING METHODS AND SYSTEMS,” filed Jan. 24, 2003 by Micklash II et al., the disclosures of which are incorporated by reference in their entirety for all purposes.

As noted above, the systems of the present invention typically include at least one computer (or other information appliance) operably connected to or included within various system components. The computer typically includes system software that directs the handling and fluid direction systems to, e.g., deliver various reagents (e.g., different components or building blocks, scaffolds, or the like) to selected reaction wells of reaction blocks, deliver gases to maintain inert environments within reaction wells via the arrays of needles, or the like. Additionally, the handling system and/or the fluid direction system is/are optionally coupled to an appropriately programmed processor or computer which functions to instruct the operation of these instruments in accordance with preprogrammed or user input instructions, receive data and information from these instruments, and interpret, manipulate and report this information to the user. As such, the computer is typically appropriately coupled to one or both of these instruments (e.g., including an analog to digital or digital to analog converter as needed).

In certain embodiments, Microsoft WINDOWS™ software written using instrument control language (ICL) scripts is adapted for use in the fluid manifolding systems of the invention. Optionally, standard desktop applications such as word processing software (e.g., Microsoft Word™ or Corel WordPerfect™) and database software (e.g., spreadsheet software such as Microsoft Excel™, Corel Quattro Pro™, or database programs such as Microsoft Access™ or Paradox™) can be adapted to the present invention by inputting character strings corresponding to reagents or masses thereof. For example, the systems optionally include the foregoing software having the appropriate reagent information, e.g., used in conjunction with a user interface (e.g., a GUI in a standard operating system such as a Windows, Macintosh or LINUX system) to manipulate reagent information.

The computer can be, e.g., a PC (Intel x86 or Pentium chipcompatible DOS™, OS2™, WINDOWS™, WINDOWS NT™, WINDOWS95™, WINDOWS98™, WINDOWS200™, WINDOWS XP™, LINUX-based machine, a MACINTOSH™, Power PC, or a UNIX-based (e.g., SUN™ work station) machine) or other common commercially available computer which is known to one of skill. Software for performing, e.g., library synthesis, solid support washing, product cleavage/purification, or the like is optionally easily constructed by one of skill using a standard programming language such as Visual basic, Fortran, Basic, Java, or the like. Any controller or computer optionally includes a monitor which is often a cathode ray tube (“CRT”) display, a flat panel display (e.g., active matrix liquid crystal display, liquid crystal display), or others. Computer circuitry is often placed in a box (e.g., within the manifolding system of the invention), which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard (e.g., a touch screen, etc.) or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more of the handling system, the fluid direction system, or the like to carry out the desired operation, e.g., varying or selecting the rate or mode of movement of various system components, or the like. The computer then receives the data from the one or more sensors/detectors included within the system, and interprets the data, either provides it in a user understood format, or uses that data to initiate further controller instructions, in accordance with the programming, e.g., such as in monitoring reaction temperatures, fluid flow rates, fluid volumes, or the like.

After the fill head vacuum valve is closed, upper actuators 308 reposition fill head assembly 312 so that lower fill needle vents (see, e.g., FIG. 5) pass through cap mats on the upper surfaces of the reaction blocks and into reaction wells 212. Electrically actuated solenoid valves then open to allow pressurized air to enter fill heads 402. The pressurized air enters fill heads 402 through ports 408 in fill head manifold 400 and forces, e.g., the wash solvent into reaction wells 212. Baffles 410 are positioned under each port 408 to ensure that fill head wells 404 are emptied evenly. The wash solvent is typically allowed to sit in reaction wells 212 for a period of time specified by the user. Variable incubation times may be used to wash solid supports as generally known in the art. Optionally, reaction block carrier 200 is removed from fluid manifolding system 600 at this time, e.g., if the procedure includes a heating step, an agitation step, and/or the like at a separate work station.

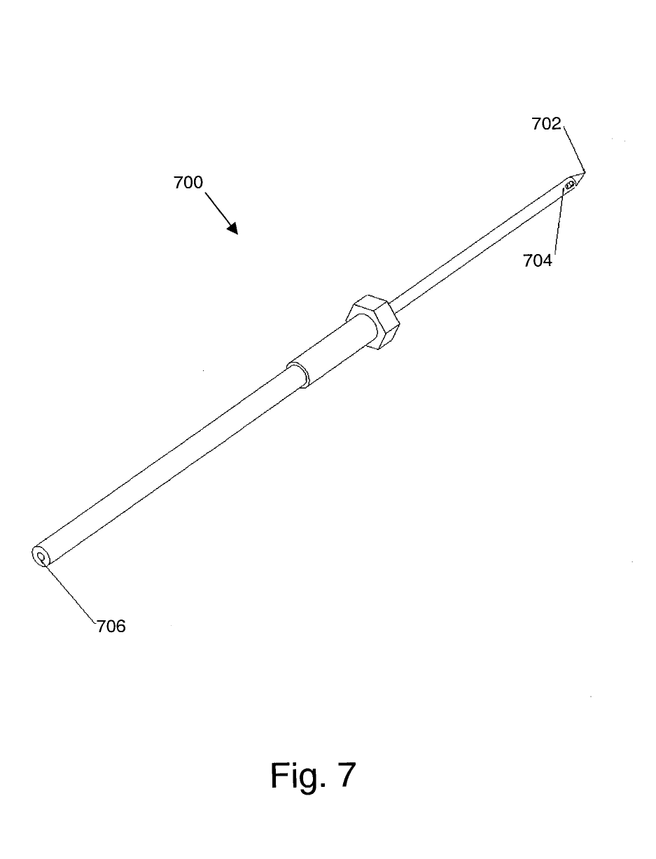

Once the specified wash time has passed, two lower actuators 604, which form additional components of the handling systems of the manifolding devices and systems of the invention, are activated. Lower actuators 604 control the position of carrier assembly 300 and reaction block carrier 200 together. On the base of fluid manifolding system 600, suction needles 606 are mounted. There is typically the same number of suction needles 606 as fill needles, which are mounted to the base of the device in a pattern that corresponds to the fill needles. FIG. 7 schematically illustrates one embodiment of a suction needle. As shown, suction needle 700 includes pencil point tip 702, inlet 704, and outlet 706. The outlets of suction needles 606 open into vacuum chamber 608. Lower actuators 604 position carrier assembly 300 so that suction needles 606 pierce cap mats disposed on the bottom surfaces of the reaction blocks in reaction block carrier 200 and the inlets of suction needles 606 enter the reaction wells.

When suction needles 606 are in position, vacuum is applied to the vacuum chamber. The vacuum used in this process is typically created using the same vacuum system as described above. The vacuum line leading to the vacuum chamber is tied into the main vacuum line. When vacuum is applied to the vacuum chamber, wash solvent is pulled out of the reaction wells through suction needles 606 and into the vacuum chamber. This waste solvent is then pulled out of the vacuum chamber and into the waste collection system described above. The above described process typically comprises one wash cycle. Optionally, multiple wash cycles are performed. For example, if another wash cycle is selected, lower actuators 604 will raise carrier assembly 300 such that inlets to suction needle 606 are out of reaction wells 212. Upper actuators 308 will then pull fill head assembly 312 up so that the lower vent openings are no longer in reaction wells 212 and the process is then repeated as described above. If no further wash cycles are selected, lower actuators 604 raise carrier assembly 300 such that suction needles 606 have been completely removed from reaction block carrier 200. Upper actuators 308 then pull the fill head assembly 312 up to its initial position. Thereafter, reaction block carrier 200 is optionally removed from carrier assembly 300 and additional steps are optionally performed, such as additional chemical reactions, or the like.

When a chemical synthesis is completed, products are typically cleaved from the solid material in the reaction wells. For this step, reaction block carrier 200 is loaded into carrier assembly 300 as described above. In addition, collection blocks 610 are loaded into the device to collect the products upon cleavage. Collection blocks 610 are typically first placed into tray 612, and tray 612 is located onto sliding table 614 that is attached to the vacuum chamber. Sliding table 614 is pushed into a tub and located with spring/ball detents 616. Once tray 612 is in position, handle 618 is turned. Handle 618 is connected to cam mechanism 620 that raises tray 612 and collection blocks 610 into position. Collection blocks 610 are in position when the outlets from suction needles 606 have just entered the wells on collection blocks 610.

Cleavage processes are typically performed in the manner of a wash, e.g., with the exception that the wash solvent contains the cleavage products, which are collected instead of being directed to waste containers. For example, after addition of one or more cleavage solvents and incubation for a selected period of time, lower actuators 604 position carrier assembly 300 such that suction needles 606 pierce the cap mats disposed on the lower surfaces of the reaction blocks so that the inlets of suction needles 606 enter reaction wells 212. During the incubation period, reaction block carrier 200 is optionally removed from fluid manifolding system 600, e.g., if the procedure includes heating steps, agitation steps, and/or the like at a different work station. A vacuum is then typically applied to the vacuum chamber, which pulls the fluid from each reaction well 212 through suction needles 606 and into corresponding wells in collection blocks 610. Positive pressure is optionally applied to the fluids in each reaction well 212 from above, e.g., simultaneous with the applied vacuum from below each reaction well 212. After product collection, all actuators return to their initial positions. Vacuum door 622 can then be opened to remove collection blocks 610. Collection block removal is done by reversing the collection block loading process described above.

The manifolding devices and systems of the invention are set up to ensure the safety of the operator in addition to providing ease of use and service. For example, the device will not run when solvent runs out, when doors 624 are open, or when flow sensors detect problems in the lines. In addition, protector plate 412 is included to ensure that the operator cannot gain access to the sharp fill needles 406. Further, when locator bolts 316, which are used to secure fill head manifold 400 are pulled back, fill head assembly 312 rotates to allow a user to inspect fill needles 406 and replace any, if necessary. The device is also typically operably connected to an exhaust system to remove solvent fumes.

Although the foregoing discussion has emphasized the utility of the devices and systems of the invention in the performance of various washing and/or cleavage processes merely for purposes of clarity and illustration, it will be appreciated by persons of skill in the art that the invention is optionally adapted to myriad other uses. In particular, the manifolding devices and systems of the present invention are designed for use in essentially any chemical synthesis procedure, including solid- or solution-phase organic synthesis. The devices of the invention provide particular utility where numerous, individual reactions are performed simultaneously and, e.g., where filtration is a necessary step during the synthesis and/or workup process. Other exemplary uses for the manifolding devices and systems of the invention include performing multiple, simultaneous chromatographic or affinity-based separations/purifications. To illustrate, each reaction well of reaction blocks sealed, e.g., within reaction block carriers optionally serves as a column for chromatographic separation of chemical mixtures on, e.g., silica gel, alumina, or many other adsorbents/resins that are commonly known in the relevant art. The elution of samples or other materials is typically gravity-based or dependent on an applied pressure.

The devices and systems of the invention are also optionally used to process various biological samples. For example, large numbers of microorganisms, including anaerobic organisms, or tissue samples can be cultured in parallel in the reaction wells in these devices. Methods of culturing tissues or cells are described in various publications including, e.g., Ausubel et al., eds., Current Protocols in Molecular Biology, a joint ventures between Greene Publishing Associates, Inc. and John Wiley & Sons, Inc. (supplemented through 2000), Freshney, Culture of Animal Cells, a Manual of Basic Technique, 3^{rd} Ed., Wiley-Liss (1994), and Humason, Animal Tissue Techniques, 4^{th} Ed., W. H. Freeman and Company (1979), and the references cited therein. Other non-limiting illustrations include performing various cell-based assays, such as pharmaceutical candidate screening, apoptosis analyses, or many other assays known in the art. Components of cell lysates are also optionally separated using, e.g., frit materials or assorted commonly known resins disposed in the arrays of reaction wells of the devices of the invention.

### III. EXAMPLES

The following non-limiting examples are offered only to briefly illustrate certain synthesis/purification protocols that are optionally performed using the devices and systems of the present invention. Particular reagents, solid supports, scavengers, or the like that are referred to only schematically in the following examples are generally known in the art. Additional details regarding synthetic pathways, purification techniques, and other processes optionally performed in the devices and systems of the invention are described in, e.g., Seneci, Solid-Phase Synthesis and Combinatorial Technologies, John Wiley & Sons, Inc. (2000), Albericio and Kates, Solid-Phase Synthesis: A Practical Guide, Marcel Dekker (2000), An and Cook (2000) “Methodologies for generating solution-phase combinatorial libraries,” Chem. Rev. 100:3311-3340, Wu (Ed), Column Handbook for Size Exclusion Chromatography, Harcourt Brace & Company (1998), and in the references cited therein. Other general resources include, e.g., March, Advanced Organic Chemistry: Reactions, Mechanisms, and Structure, 4^{th} Ed., John Wiley & Sons, Inc. (1992), Smith and March, March's Advanced Organic Chemistry: Reactions, Mechanisms, and Structure, 5^{th} Ed., John Wiley & Sons, Inc. (2001), Carey and Sundberg, Advanced Organic Chemistry Part A: Structure and Mechanism, 4^{th} Ed., Plenum Press (2000), and in the references provided therein.

A. Solid-Support-Bound Reagent-Based Procedures

Purification Processes Involving Excess Solution Compounds

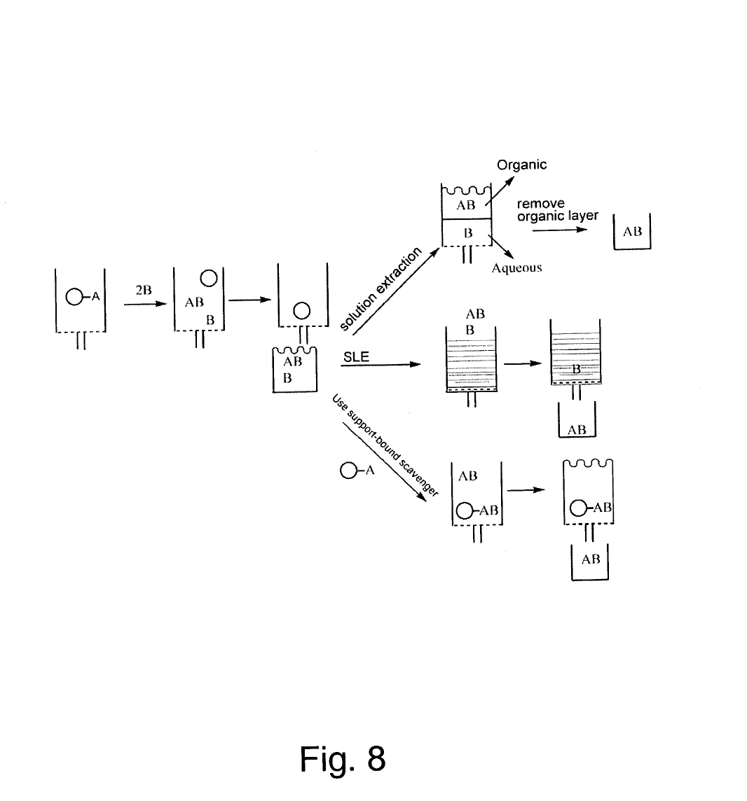

FIG. 8 schematically depicts solution extraction, solid liquid extraction (SLE), and reactive support material purification procedures for reactions involving excess solution compounds. As shown, the general reaction includes reacting a support-bound reactant (depicted as A) with a liquid-phase reactant (depicted as B), which cleaves A from the support to yield a liquid-phase product (depicted as AB) with excess B. Following the reaction, the solid supports are washed and the liquid-phase which includes AB and B is filtered, e.g., through a TEFLON® frit in a reaction well of a reaction block, to separate the liquid-phase from the solid supports. The filtrate or liquid-phase is then subjected to a purification process to separate AB from B.

Solution extractions typically use two immiscible phases to separate a solute from one phase into the other, e.g., separating organic or hydrophobic compounds out of an aqueous phase and into an organic phase. The distribution of a solute between two phases is an equilibrium condition described by partition theory. As schematically illustrated in the solution extraction of FIG. 8, AB is an organic compound that partitions into an organic phase, whereas B is a hydrophilic reagent that partitions into an aqueous phase and AB purification is effected by removing the organic phase from contact with the aqueous phase.

Another purification protocol that is optionally performed in the devices of the invention is a solid liquid extraction. This protocol typically includes reloading the filtrate into a reaction well of a reaction block that includes a frit of filter material and a solid support that has been prepared with an appropriate solvent disposed therein. As schematically shown, AB separates from B in the reaction well and the liquid-phase that includes AB is collected from the reaction well. Optionally, the solid support in the reaction well is washed and the liquid-phase from the wash additionally collected from the reaction well.

Reactive support materials or support-bound scavengers are also optionally used to effect product purification in the devices of the present invention. As schematically depicted in FIG. 8, the filtrate is added to a reaction well of a reaction block that includes a filter and solid supports with bound A. The reactive solid supports is typically wet prior to the addition of the filtrate. Upon filtrate addition, the support-bound scavengers react with B in the filtrate to produce solid supports with bound AB. Following this reaction, the liquid phase which includes the AB product is separated from the solid supports by filtration to effect product purification.

Purification Process Involving Limiting Liquid-Phase Compounds

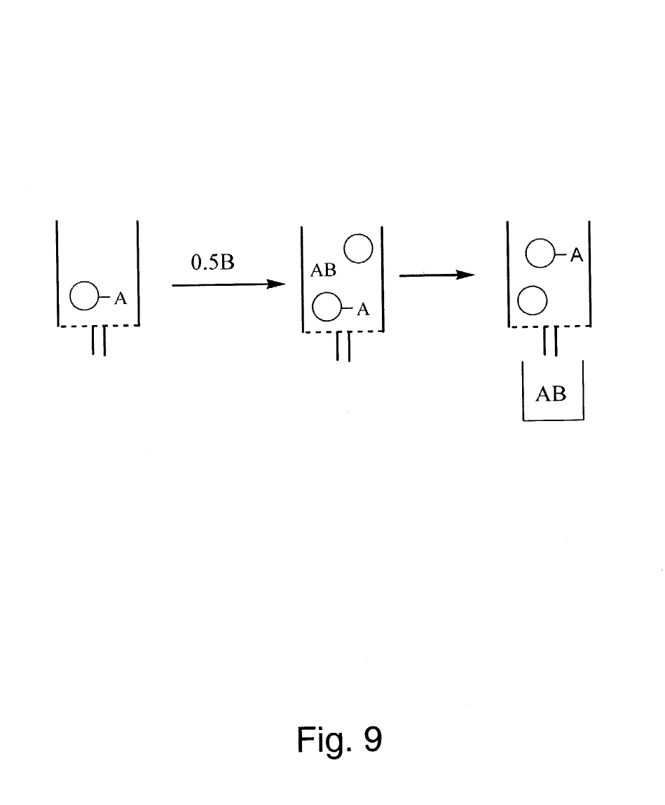

FIG. 9 schematically illustrates a purification process that includes the use of limiting amounts of liquid-phase compounds. As shown, pre-solvated solid support-bound reactant A is reacted with a limiting amount of a liquid-phase reactant B in a reaction well of a reaction block that includes a filter. Reactant B cleaves reactant A from the solid support to yield product AB in solution and excess support-bound A. Thereafter, AB is separated from the excess support-bound A and free solid supports in the reaction well by filtration. The support material in the reaction well is optionally washed and filtrate collected.

B. Solution-Phase Libraries

Purification Process Involving Support-Bound Scavengers

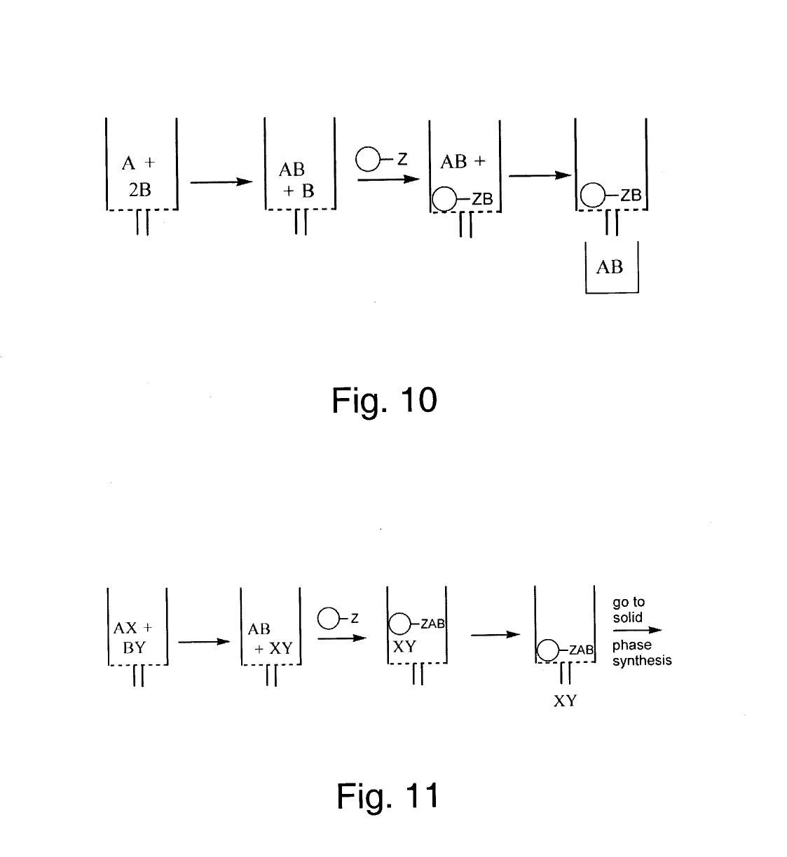

FIG. 10 schematically shows a purification procedure that includes the use of support-bound scavengers to remove reaction impurities and/or side products. As shown, reactant A is reacted with an excess of reactant B to yield product AB and excess B in a reaction well of a reaction block that is fitted with a filter. Thereafter, a scavenger solid support with bound reactant Z is added to the reaction well, which scavenger reacts with the excess B in the solution to produce solid supports with bound ZB. The product AB is then collected (e.g., in a well of a collection block, etc.) after being separated from the solid supports with bound ZB in the reaction wells by filtration. Optionally, the solid supports are washed and the resulting filtrate is collected.

Purification Process Involving Solid Support Recapture

FIG. 11 schematically depicts a purification protocol that involves solid support capture. As shown, liquid-phase reagents AX and BY are reacted in a reaction well of a reaction block that includes a filtering frit to produce product AB and byproduct XY. To capture AB, solid supports with bound reagent Z are added to the reaction well, which react with AB to produce solid supports with bound ZAB. Thereafter, byproduct XY is separated from the solid support in the filtrate. The separated supports with bound ZAB are optionally used in additional rounds of solid-phase synthesis.

Purification Process Involving Solid Supported Liquid Extraction

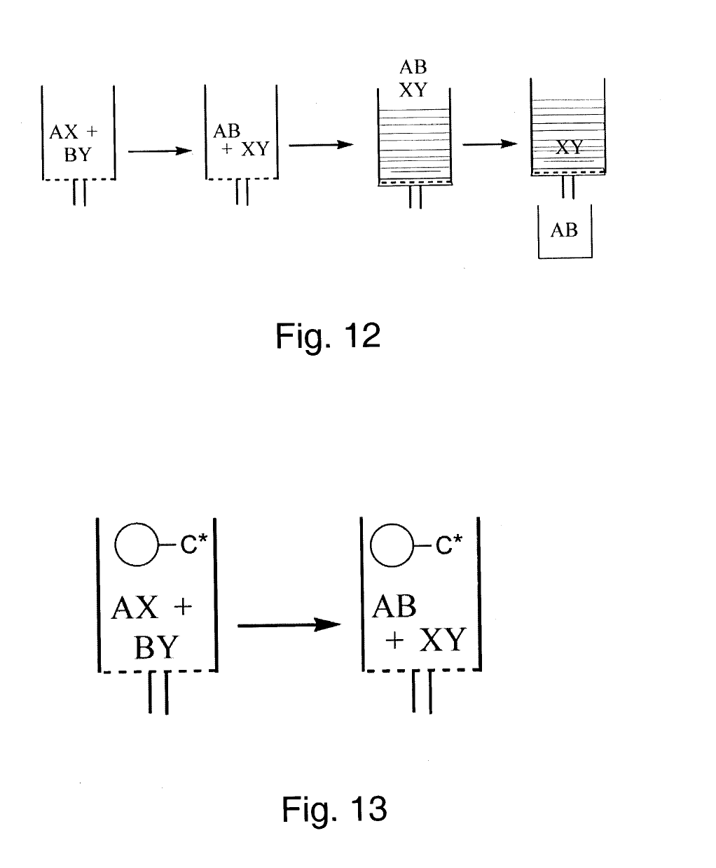

FIG. 12 schematically illustrates a purification procedure that involves solid supported liquid extraction (SLE). As shown, liquid-phase reagents AX and BY are reacted in a reaction well of a reaction block that includes a filtering frit to produce product AB and byproduct XY. The product AB and byproduct XY in the liquid-phase are then loaded into another reaction well of a reaction block that includes support material and a filter disposed within (i.e., an SLE block). Product AB and byproduct XY separate as they pass through the support material and product AB is collected upon passing through the filter. Optionally, the SLE block is washed and liquid is collected.

Purification Process Involving Support-Bound Catalysis

FIG. 13 schematically shows a purification procedure that includes support-bound catalysis. As shown, liquid-phase reagents AX and BY are reacted in the presence of a support-bound catalyst (C*) in a reaction well of a reaction block that includes a filtering frit to produce product AB and byproduct XY. The product AB and byproduct XY are optionally separated using, e.g., solid support recapture (described above), solid supported liquid extraction (described above), or the like.

Synthesis/Purification Process Involving Multistep Solid Phase Synthesis

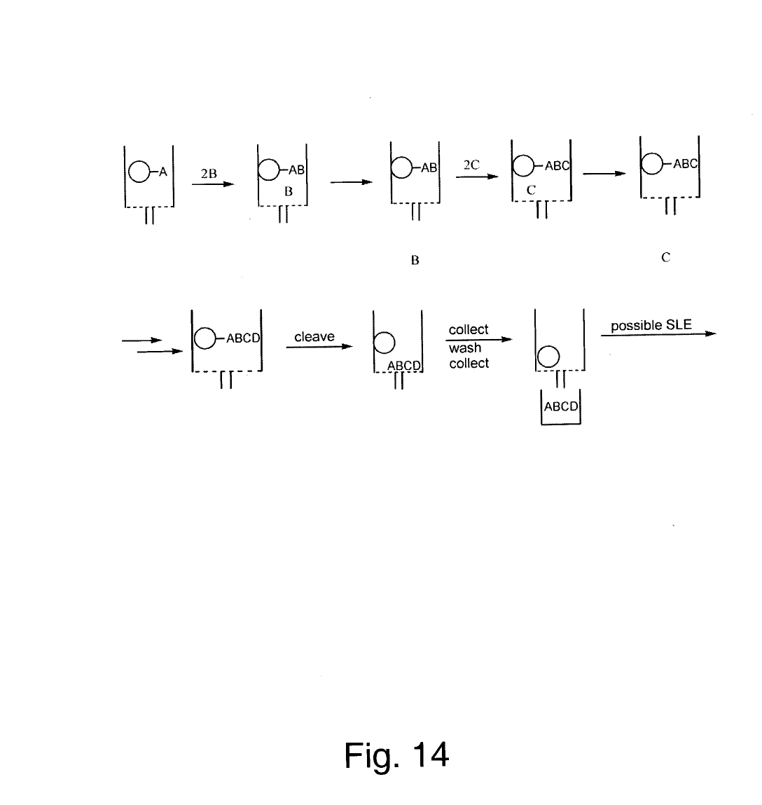

FIG. 14 schematically shows a synthesis/purification procedure that includes support-bound catalysis. As shown, support-bound reactant A in a reaction well of a reaction block that includes a filter is reacted with an excess of liquid-phase reactant B to produce support-bound AB. After excess B is washed and filtered from the reaction well, support-bound AB is reacted with an excess of liquid-phase reactant C to produce support-bound ABC. After excess C is washed and filtered from the reaction well, support-bound ABC is reacted with an excess of liquid-phase reactant D to produce support-bound ABCD. After excess D is washed and filtered from the reaction well, product ABCD is cleaved from the support, the support is washed and filtrate that includes product ABCD is collected. If other byproducts are present in the collected fraction, additional purification procedures are optionally performed, such as solid supported liquid extraction (described above), lyophilization, liquid/liquid extraction, covalent capture, ion exchange, or essentially any other purification process known in the art.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

What is claimed is:

1. A manifolding device, comprising:
(a) at least one first material conduit in communication with at least one first container, which first material conduit is capable of removably accessing one or more reaction wells of at least one reaction block through one or more first openings in a first surface of the reaction block to communicate with the reaction wells;
(b) at least one second material conduit in communication with at least one second container, which second material conduit is capable of removably accessing the reaction wells of the reaction block through one or more second openings in a second surface of the reaction block to communicate with the reaction wells; and,
(c) at least one material direction component operably connected to the first material conduit, the second material conduit, or both the first and second material conduits, which material direction component is capable of moving one or more materials to or from the reaction wells.

2. The manifolding device of claim 1, wherein at least one reaction well further comprises a filter disposed therein.

3. The manifolding device of claim 1, wherein the reaction block comprises a footprint that corresponds to wells in a micro-well plate.

4. The manifolding device of claim 1, wherein the first material conduit and/or the second material conduit comprises at least one needle.

5. The manifolding device of claim 1, wherein the first and second containers are independently selected from one or more of: solid-phase material containers, liquid-phase material containers, or gaseous-phase material containers.

6. The manifolding device of claim 1, wherein the materials of (c) comprise one or more of: solid-phase materials, liquid-phase materials, or gaseous-phase materials.

7. The manifolding device of claim 1, wherein the material direction component comprises at least one pressure-force modulator capable of selectively applying positive or negative pressure to the first material conduit, the second material conduit, or both the first and second material conduits.

8. The manifolding device of claim 1, wherein at least one handling system is operably connected to one or more of the first material conduit, the second material conduit, or the reaction block to move the first material conduit, the second material conduit, and/or the reaction block relative to one another to effect removable access of the reaction wells by the first material conduit, the second material conduit, or both the first and second material conduits.

9. The manifolding device of claim 8, wherein the handling system is capable of applying at least 30 pounds of pressure per square inch of reaction block surface area accessed by the first or second material conduits.

10. The manifolding device of claim 1, wherein the first and second material conduits each comprise at least one array of material conduits, which array of material conduits is capable of axially aligning with the reaction wells of the reaction block to access and communicate with the reaction wells.

11. The manifolding device of claim 10, wherein the array of material conduits comprises at least one array of needles.

12. The manifolding device of claim 10, wherein the array of material conduits comprises multiple arrays of material conduits.

13. The manifolding device of claim 1, wherein the manifolding device comprises multiple reaction blocks.

14. The manifolding device of claim 13, wherein the multiple reaction blocks are arrayed in a reaction block carrier in which at least one reaction well is accessible by both the first and second material conduits.

15. The manifolding device of claim 14, wherein the multiple reaction blocks are sealed by cap mats, gasketing sheets, or both cap mats and gasketing sheets disposed between a portion of the reaction block carrier and the multiple reaction blocks.

16. The manifolding device of claim 15, wherein the first and second fluid conduits are capable of accessing the multiple reaction blocks by piercing the cap mats, the gasketing sheets, or both the cap mats and the gasketing sheets.

17. A fluid manifolding device, comprising:
(a) at least one first array of needles in fluid communication with at least one first fluid container, which first array of needles is capable of removably accessing reaction wells of at least one reaction block through one or more first openings in a first surface of the reaction block to fluidly communicate with the reaction wells, wherein the reaction block is disposed in a multiple reaction block carrier;
(b) at least one second array of needles in fluid communication with at least one second fluid container, which second array of needles is capable of removably accessing the reaction wells of the reaction block through one or more second openings in a second surface of the reaction block to fluidly communicate with the reaction wells; and,
(c) at least one fluid direction component operably connected to the first array of needles, the second array of needles, or both the first and second arrays of needles, which fluid direction component is capable of flowing one or more fluidic materials to or from the reaction wells.

18. The fluid manifolding device of claim 17, wherein at least one reaction well further comprises a filter disposed therein.

19. The fluid manifolding device of claim 17, wherein at least one member of the first and second arrays of needles comprises at least one channel disposed at least partially therethrough, which channel comprises at least one first opening disposed proximal to a terminus of the needle and at least one second opening disposed along a length of the member.

20. The fluid manifolding device of claim 17, wherein the reaction block comprises 6, 12, 24, 48, 96, 384, 1536, or more reaction wells.

21. The fluid manifolding device of claim 17, wherein the first surface comprises a top surface of the reaction block.

22. The fluid manifolding device of claim 17, wherein the second surface comprises a bottom surface of the reaction block.

23. The fluid manifolding device of claim 17, wherein the first fluid container comprises at least one fluidic material source.

24. The fluid manifolding device of claim 17, wherein the second fluid container comprises at least one waste container or at least one collection block.

25. The fluid manifolding device of claim 17, wherein the first or second fluid container comprises multiple fluid containers.

26. The fluid manifolding device of claim 17, wherein the fluid direction component comprises a pressure force modulator capable of selectively applying positive or negative pressure to the first array of needles, the second array of needles, or both the first and second arrays of needles.

27. The fluid manifolding device of claim 17, wherein the fluidic materials comprise one or more of: solid supports, reagents, reactants, products, buffers, solvents, wash solvents, or cleavage solvents.

28. The fluid manifolding device of claim 17, wherein the first and second arrays of needles are capable of axially aligning with the reaction wells of the reaction block to access and communicate with the reaction wells.

29. The fluid manifolding device of claim 17, wherein the first and second arrays of needles each independently comprise 6, 12, 24, 48, 96, 384, 1536, or more members in the arrays of needles.

30. The fluid manifolding device of claim 17, wherein the device comprises one or more alignment structures, which alignment structures align the reaction block carrier relative to the device.

31. The fluid manifolding device of claim 17, wherein the first or second fluid container comprises at least first and second waste containers that fluidly communicate with a line connecting the fluid direction component to the first array of needles, the second array of needles, or both the first and second arrays of needles, and wherein the system further comprises:
a scale located under each waste container to detect fluid levels for the waste containers; and,
a solenoid valve that is operably connected to the line, which solenoid valve selects which waste container into which to flow waste fluid.

32. The fluid manifolding device of claim 31, wherein a user directs the solenoid valve to direct the waste fluid to a particular waste container.

33. The fluid manifolding device of claim 31, wherein the solenoid valve directs the waste fluid to the second waste container when the first waste container reaches a specified weight.

34. The fluid manifolding device of claim 33, wherein a user is alerted when the first waste container reaches the specified weight.

35. The fluid manifolding device of claim 31, further comprising a vacuum pump operably connected to the line.

36. The fluid manifolding device of claim 35, further comprising a programmable logic controller operably connected to the vacuum pump to control operation of the vacuum pump.

37. The fluid manifolding device of claim 17, wherein the first and second arrays of needles each comprise multiple arrays of needles.

38. The fluid manifolding device of claim 37, wherein the multiple arrays of needles comprise 2, 3, 4, 5, 6, 7, 8, 9, 10, or more arrays of needles.

39. The fluid manifolding device of claim 17, wherein the fluid manifolding device comprises multiple reaction blocks arrayed in the reaction block carrier.

40. The fluid manifolding device of claim 39, wherein the multiple reaction blocks comprise 2, 3, 4, 5, 6, 7, 8, 9, 10, or more reaction blocks.

41. The fluid manifolding device of claim 39, wherein the multiple reaction blocks are arrayed in one or more rows.

42. The fluid manifolding device of claim 17, wherein the reaction block is sealed by at least one cap mat, at least one gasketing sheet, or both at least one cap mat and at least one gasketing sheet disposed between a portion of the reaction block carrier and the reaction block.

43. The fluid manifolding device of claim 42, wherein the first and second arrays of needles are capable of accessing the reaction block by piercing the cap mat, the gasketing sheet, or both the cap mat and the gasketing sheet.

44. The fluid manifolding device of claim 42, wherein each cap mat comprises at least one protrusion, which protrusion axially aligns with at least one reaction well.

45. The fluid manifolding device of claim 17, wherein at least one handling system is operably connected to one or more of the first array of needles, the second array of needles, or the reaction block, which handling system is capable of moving the first array of needles, the second array of needles, and/or the reaction block relative to one another to effect removable access of the reaction wells of the reaction block by the first array of needles, the second array of needles, or both the first and second arrays of needles.

46. The fluid manifolding device of claim 45, wherein the handling system is capable of applying at least 30 pounds of pressure per square inch of reaction block surface area accessed by the first or second arrays of needles.

47. A reaction block carrier comprising a support structure, which support structure is capable of laterally arraying and sealing two or more reaction blocks in substantially fixed positions relative to the support structure, wherein at least one reaction well of at least one reaction block is accessible.

48. The reaction block carrier of claim 47, wherein the support structure comprises a metallic or polymeric material.

49. The reaction block carrier of claim 47, wherein the two or more reaction blocks comprise 3, 4, 5, 6, 7, 8, 9, 10, or more reaction blocks.

50. The reaction block carrier of claim 47, wherein the reaction blocks are arrayed in one or more rows.

51. The reaction block carrier of claim 47, wherein the reaction blocks each independently comprise 6, 12, 24, 48, 96, 384, 1536, or more reaction wells.

52. The reaction block carrier of claim 47, wherein the reaction well is accessible by one or more needles.

53. The reaction block carrier of claim 47, wherein the support structure comprises a top portion attached to a bottom portion by at least one attachment component, wherein the reaction blocks are disposed within the support structure.

54. The reaction block carrier of claim 53, wherein the at least one attachment component comprises at least one hinge, at least one latch, or at least one hinge and at least one latch.

55. The reaction block carrier of claim 53, wherein the top portion, the bottom portion, or both the top and bottom portions comprise at least one protrusion disposed on a surface that engages the reaction blocks, which protrusion presses a cap mat into contact with an inlet portion of the reaction blocks to seal the inlet portion.

56. The reaction block carrier of claim 53, wherein the top portion is removably attached to the bottom portion.

57. The reaction block carrier of claim 53, wherein the support structure comprises at least one handle.

58. The reaction block carrier of claim 53, wherein the top and bottom portions each comprise at least one alignment structure, which alignment structure aligns the reaction blocks relative to the support structure or the support structure relative to a fluid manifolding device.

59. The reaction block carrier of claim 53, wherein the top and bottom portions comprise one or more arrays of apertures disposed through the top and bottom portions, wherein at least one aperture axially aligns with the reaction well.

60. The reaction block carrier of claim 59, wherein the aperture is tapered.

61. The reaction block carrier of claim 47, wherein the reaction blocks are sealed by cap mats disposed between a portion of the support structure and the reaction blocks.

62. The reaction block carrier of claim 61, further comprising gasketing sheets disposed between the cap mats and the portion of the support structure to further seal the reaction blocks.

63. The reaction block carrier of claim 61, wherein each cap mat comprises at least one protrusion, which protrusion axially aligns with the reaction well.

64. The reaction block carrier of claim 61, wherein each cap mat comprises an array of protrusions, wherein each protrusion axially aligns with a different reaction well.

65. The reaction block carrier of claim 61, wherein the cap mats comprise silicon.

66. The reaction block carrier of claim 65, wherein the cap mats further comprise a hydrophilic or a hydrophobic coating.

67. A fluid manifolding system, comprising:
(a) at least one reaction block; and,
(b) at least one fluid manifolding device comprising:
(i) at least one first fluid conduit in fluid communication with at least one first fluid container, which first fluid conduit is capable of removably accessing one or more reaction wells of the reaction block through one or more first openings in a first surface of the reaction block to fluidly communicate with the reaction wells;
(ii) at least one second fluid conduit in fluid communication with at least one second fluid container, which second fluid conduit is capable of removably accessing the reaction wells of the reaction block through one or more second openings in a second surface of the reaction block to fluidly communicate with the reaction wells; and
(iii) at least one fluid direction component operably connected to the first fluid conduit, the second fluid conduit, or both the first and second fluid conduits, which fluid direction component is capable of flowing one or more fluidic materials to or from the reaction block.

68. The fluid manifolding system 67, further comprising:
(c) at least one computer operably connected to the fluid manifolding device, the computer comprising system software which directs the fluid manifolding device to:
(i) access the reaction block with the first fluid conduit, the second fluid conduit, or both the first and second fluid conduits to establish fluid communication between the reaction wells and the fluid manifolding device; and
(ii) flow one or more fluidic materials to or from the reaction wells through the first fluid conduit, the second fluid conduit, or both the first and second fluid conduits.

69. A handling system, comprising at least one actuator operably connected to one or more of at least a first array of needles, at least a second array of needles, or at least one reaction block, which actuator is capable of moving the first array of needles, the second array of needles, and/or the reaction block relative to one another to effect removable access of reaction wells disposed within the reaction block by the first array of needles, the second array of needles, or both the first and second arrays of needles.

70. The handling system of claim 69, wherein the at least one actuator comprises multiple actuators.

71. The handling system of claim 69, wherein the actuator is capable of applying at least 30 pounds of pressure per square inch of reaction block surface area accessed by the first array of needles or the second array of needles.

72. The handling system of claim 69, wherein the first and second arrays of needles substantially oppose one another.

73. The handling system of claim 69, wherein the first and second arrays of needles access the reaction wells through different surfaces of the reaction block.

74. The handling system of claim 69, wherein each of the first and second arrays of needles comprises multiple arrays of needles.

75. The handling system of claim 69, wherein the reaction wells disposed within the reaction block are sealed by cap mats, gasketing sheets, or both cap mats and gasketing sheets.

76. The handling system of claim 75, wherein the first array of needles, the second array of needles, or both the first and second arrays of needles access the reaction wells by piercing the cap mats, the gasketing sheets, or both the cap mats and gasketing sheets.

77. The handling system of claim 69, wherein the at least one reaction block comprises multiple reaction blocks.

78. The handling system of claim 77, wherein the multiple reaction blocks are arrayed and sealed in a reaction block carrier.

79. A needle comprising at least one channel disposed at least partially therethrough, which channel comprises at least one first opening disposed proximal to a terminus of the needle and two or more second openings disposed along a length of the needle.

80. The needle of claim 79, wherein the second openings are coaxially aligned along the length of the needle.

81. A cap mat comprising a sheet of flexible material comprising an array of protrusions disposed on at least one surface of the sheet of flexible material, which array of protrusions is capable of axially aligning with an array of reaction wells disposed in or through a reaction block to seal the reaction wells.

82. The cap mat of claim 81, wherein the flexible material comprises silicon.

83. The cap mat of claim 81, further comprising at least one hydrophilic or at least one hydrophobic coating disposed on one or more surfaces of the sheet of flexible material.

84. A method of fluidly communicating with one or more reaction wells of at least one reaction block, the method comprising:
(a) providing a fluid manifolding device comprising:
(i) at least one first fluid conduit in fluid communication with at least one first fluid container, which first fluid conduit is capable of removably accessing the reaction wells of the reaction block through one or more first openings in a first surface of the reaction block to fluidly communicate with the reaction wells;
(ii) at least one second fluid conduit in fluid communication with at least one second fluid container, which second fluid conduit is capable of removably accessing the reaction wells of the reaction block through one or more second openings in a second surface of the reaction block to fluidly communicate with the reaction wells; and
(iii) at least one fluid direction component operably connected to the first fluid conduit, the second fluid conduit, or both the first and second fluid conduits, which fluid direction component is capable of flowing one or more fluidic materials to or from the reaction wells;
(b) positioning the reaction block relative to the fluid manifolding device such that the fluid manifolding device is capable of fluidly communicating with the reaction wells;
(c) accessing the reaction wells with the first fluid conduit, the second fluid conduit, or both the first and second fluid conduits to establish fluid communication between the reaction wells and the fluid manifolding device; and,
(d) flowing the one or more fluidic materials to or from the reaction wells through the first fluid conduit, the second fluid conduit, or both the first and second fluid conduits, thereby fluidly communicating with the reaction wells.

85. The method of claim 84, wherein the fluidic materials of step (d) comprise one or more of: solid supports, reagents, reactants, products, buffers, solvents, wash solvents, or cleavage solvents.

86. The method of claim 84, wherein the reaction wells further comprise filters disposed therein.

87. The method of claim 84, wherein at least one cap mat seals the reaction wells of the reaction block and (c) comprises piercing the cap mat with the first and/or second fluid conduit.

88. The method of claim 84, wherein the first or second fluid container comprises at least first and second waste containers that fluidly communicate with a line connecting the fluid direction component to the first fluid conduit, the second fluid conduit, or both the first and second fluid conduits, wherein the system further comprises a scale located under each waste container to detect fluid levels for the waste containers, and a solenoid valve that is operably connected to the line, which solenoid valve selects which waste container into which to flow waste fluid, and the method further comprises:
(e) directing the waste fluid to the second waste container when the first waste container reaches a specified weight using the solenoid valve.

89. The method of claim 88, wherein the method further comprises:
(f) alerting a user when the first waste container reaches the specified weight.

90. The method of claim 84, further comprising performing one or more parallel synthesis reactions in the reaction wells of the reaction block prior to (a).

91. The method of claim 90, wherein the parallel synthesis reactions comprise solid phase synthesis reactions or liquid phase synthesis reactions.

92. The method of claim 84, further comprising:
(e) withdrawing the first fluid conduit, the second fluid conduit, or both the first and second fluid conduits from the reaction block.

93. The method of claim 92, further comprising:
(f) repeating (c)-(e).

94. The method of claim 84, wherein (d) comprises flowing one or more wash solvents through the first fluid conduit into the reaction block to wash solid supports disposed within the reaction wells.

95. The method of claim 94, wherein (d) further comprises flowing the wash solvents from the reaction block through the second fluid conduit.

96. The method of claim 84, wherein (d) comprises flowing one or more cleavage solvents through the first fluid conduit into the reaction block to cleave products from solid supports disposed within the reaction wells.

97. The method of claim 96, wherein (d) further comprises flowing the cleavage solvents, products, or solid supports from the reaction block through the second fluid conduit.

98. The method of claim 84, wherein the reaction wells comprise filters disposed therein capable of retaining solid supports in the reaction wells and wherein (d) comprises:
(i) flowing a first fluid comprising one or more substrates attached to one or more solid supports through the first fluid conduit into the reaction wells of the reaction block; and,
(ii) flowing a second fluid comprising one or more first chemical substituents through the first fluid conduit into the reaction wells of the reaction block, which first chemical substituents react with the substrates to produce one or more first products attached to the one or more solid supports.

99. The method of claim 98, wherein the first and second fluids are flowed from different first fluid containers.

100. The method of claim 98, further comprising flowing at least a portion of the first and second fluids from the reaction wells prior to (ii), wherein the solid supports are retained in the reaction wells by the filters.

101. The method of claim 100, further comprising:
(iii) flowing one or more wash solvents through the first fluid conduit into the reaction wells to wash the solid supports; and,
(iv) flowing the wash solvents from the reaction wells through the second fluid conduit.

102. The method of claim 101, further comprising:
(v) flowing one or more cleavage solvents through the first fluid conduit into the reaction wells to cleave the first products from the solid supports; and,
(vi) flowing the first products from the reaction wells through the second fluid conduit.

103. The method of claim 101, further comprising:
(v) flowing a third fluid comprising one or more second chemical substituents through the first fluid conduit into the reaction wells of the reaction block, which second chemical substituents react with the first products to produce one or more second products attached to the one or more solid supports.

104. A method of fluidly communicating with one or more wells of at least one reaction block, the method comprising:
(a) providing a fluid manifolding device comprising:
(i) at least one first array of needles in fluid communication with at least one first fluid container, which first array of needles is capable of removably accessing the reaction wells of the reaction block through one or more first openings in a first surface of the reaction block to fluidly communicate with the reaction wells, wherein the reaction block is disposed in a reaction block carrier;
(ii) at least one second array of needles in fluid communication with at least one second fluid container, which second array of needles is capable of removably accessing the reaction wells of the reaction block through one or more second openings in a second surface of the reaction block to fluidly communicate with the reaction wells; and
(iii) at least one fluid direction component operably connected to the first array of needles, the second array of needles, or both the first and second arrays of needles, which fluid direction component is capable of flowing one or more fluidic materials to or from the reaction wells;
(b) positioning the reaction block relative to the fluid manifolding device such that the fluid manifolding device is capable of fluidly communicating with the reaction wells;
(c) accessing the reaction wells of the reaction block with the first array of needles, the second array of needles, or both the first and second arrays of needles to establish fluid communication between the reaction wells and the fluid manifolding device; and,
(d) flowing the one or more fluidic materials to or from the reaction wells of the reaction block through the first array of needles, the second array of needles, or both the first and second array of needles, thereby fluidly communicating with the reaction wells.

105. A method of sealing reaction wells in one or more reaction blocks, the method comprising:
(a) providing a multiple reaction block carrier comprising a support structure, which support structure is capable of laterally arraying and sealing two or more reaction blocks in substantially fixed positions relative to the support structure;
(b) providing at least one reaction block comprising an array of reaction wells disposed through the reaction block;
(c) positioning an array of protrusions of a first cap mat in openings to the array of reaction wells disposed on a first surface of the reaction block of step (b) and an array of protrusions of a second cap mat in openings to the array of reaction wells disposed on a second surface of the reaction block of step (b); and,
(d) positioning the reaction block of step (c) in the multiple reaction block carrier of step (a), thereby sealing the reaction wells in the reaction block.

106. The method of claim 105, further comprising positioning a first gasketing sheet over the first cap mat and a second gasketing sheet over the second cap mat prior to step (d).

107. The method of claim 106, wherein the first and second gasketing sheets further seal the reaction wells.
